(19) United States
(12) Patent Application Publication
(10) Pub. No.: US 2025/0317503 A1
(43) Pub. Date: Oct. 9, 2025

(54) INFORMATION TRANSMISSION METHOD AND APPARATUS, AND COMMUNICATION DEVICE

(71) Applicant: VIVO MOBILE COMMUNICATION CO., LTD., Guangdong (CN)

(72) Inventor: Li CHEN, Guangdong (CN)

(73) Assignee: VIVO MOBILE COMMUNICATION CO., LTD., Guangdong (CN)

(21) Appl. No.: 19/243,186

(22) Filed: Jun. 19, 2025

Related U.S. Application Data
(63) Continuation of application No. PCT/CN2023/138029, filed on Dec. 12, 2023.

(30) Foreign Application Priority Data
Dec. 19, 2022 (CN) 202211635448.1

(51) Int. Cl. H04L 69/321; H04L 69/06

(52) U.S. Cl. CPC H04L 69/321; H04L 69/06

(57) ABSTRACT

This application discloses an information transmission method and an apparatus, and a communication device. The information transmission method of embodiments of this application includes: performing, by a first protocol layer entity, a first operation, where the first operation includes at least one of the following: sending first information to a second protocol layer entity, where the first information is used for requesting information about a data object associated with a data object of the first protocol layer entity from the second protocol layer entity; and receiving second information from the second protocol layer entity, where the second information is a first response message to the first information, or the second information includes related information of a data object of the second protocol layer entity; where the first protocol layer entity and the second protocol layer entity are located in a same communication device.

### CROSS-REFERENCE TO RELATED APPLICATIONS

This application is a continuation application of PCT International Application No. PCT/CN2023/138029 filed on Dec. 12, 2023, which claims priority to Chinese Patent Application No. 202211635448.1, filed in China on Dec. 19, 2022, which is incorporated herein by reference in its entirety.

### TECHNICAL FIELD

This application pertains to the field of communication technologies, and specifically, relates to an information transmission method and an apparatus, and a communication device.

### BACKGROUND

In related technologies, extended reality (XR) services, cloud gaming (CG) services, or the like may include multiple quality of service (QOS) flows. Different QoS flows may map to different data radio bearers (DRB). Inherent correlation is present between data packets or data packet groups mapped to different DRBs in XR or CG services. However, in a protocol stack architecture of related technologies, protocol layer entities (for example, packet data convergence protocol (PDCP) entities) corresponding to different DRBs in communication devices operate independently. Corresponding operations, such as packet loss and integrity protection, are performed independently by the protocol layer entities. This can not only lead to a waste of resources of the communication device but also result in relatively low efficiency in data processing by the communication device.

### SUMMARY

According to a first aspect, an information transmission method is provided, where the method includes:
performing, by a first protocol layer entity, a first operation, where the first operation includes at least one of the following:
sending first information to a second protocol layer entity, where the first information is used for requesting information about a data object associated with a data object of the first protocol layer entity from the second protocol layer entity, and the data object includes at least one of a data packet, a data packet group, and a service data unit SDU; and
receiving second information from the second protocol layer entity, where the second information is a first response message to the first information, or the second information includes related information of a data object of the second protocol layer entity; where
the first protocol layer entity and the second protocol layer entity are located in a same communication device.

According to a second aspect, an information transmission apparatus is provided, applied to a first protocol layer entity, where the apparatus includes:
a first execution module, configured to perform a first operation, where the first operation includes at least one of the following:
sending first information to a second protocol layer entity, where the first information is used for requesting information about a data object associated with a data object of the first protocol layer entity from the second protocol layer entity, and the data object includes at least one of a data packet, a data packet group, and a service data unit SDU; and
receiving second information from the second protocol layer entity, where the second information is a first response message to the first information, or the second information includes related information of a data object of the second protocol layer entity; where
the first protocol layer entity and the second protocol layer entity are located in a same communication device.

According to a third aspect, an information transmission method is provided, where the method includes:
performing, by a second protocol layer entity, a second operation, where the second operation includes at least one of the following:
receiving first information from a first protocol layer entity, where the first information is used for requesting information about a data object associated with a data object of the first protocol layer entity from the second protocol layer entity, and the data object includes at least one of a data packet, a data packet group, and a service data unit SDU; and
sending second information to the first protocol layer entity, where the second information is a first response message to the first information, or the second information includes related information of a data object of the second protocol layer entity; where
the first protocol layer entity and the second protocol layer entity are located in a same communication device.

According to a fourth aspect, an information transmission apparatus is provided, applied to a second protocol layer entity, where the apparatus includes:
a second execution module, configured to perform a second operation, where the second operation includes at least one of the following:
receiving first information from a first protocol layer entity, where the first information is used for requesting information about a data object associated with a data object of the first protocol layer entity from the second protocol layer entity, and the data object includes at least one of a data packet, a data packet group, and a service data unit SDU; and
sending second information to the first protocol layer entity, where the second information is a first response message to the first information, or the second information includes related information of a data object of the second protocol layer entity; where
the first protocol layer entity and the second protocol layer entity are located in a same communication device.

According to a fifth aspect, a communication device is provided, where the communication device includes a processor and a memory, where a program or instructions capable of running on the processor are stored in the memory, and when the program or the instructions are executed by the processor, the steps of the method according to the first aspect are implemented or the steps of the method according to the third aspect are implemented.

According to a sixth aspect, a communication device is provided, including a processor and a communication interface, where the communication interface is configured to perform a first operation, where the first operation includes at least one of the following: sending first information to a second protocol layer entity, where the first information is used for requesting information about a data object associated with a data object of the first protocol layer entity from the second protocol layer entity, and the data object includes at least one of a data packet, a data packet group, and a service data unit SDU; and receiving second information from the second protocol layer entity, where the second information is a first response message to the first information, or the second information includes related information of a data object of the second protocol layer entity; where the first protocol layer entity and the second protocol layer entity are located in a same communication device; or
the communication interface is configured to perform a second operation, where the second operation includes at least one of the following: receiving first information from the first protocol layer entity, where the first information is used for requesting information about a data object associated with a data object of the first protocol layer entity from the second protocol layer entity, and the data object includes at least one of a data packet, a data packet group, and a service data unit SDU; and sending second information to the first protocol layer entity, where the second information is a first response message to the first information, or the second information includes related information of a data object of the second protocol layer entity; where the first protocol layer entity and the second protocol layer entity are located in a same communication device.

According to a seventh aspect, a readable storage medium is provided, where a program or instructions are stored in the readable storage medium, and when the program or the instructions are executed by a processor, the steps of the method according to the first aspect are implemented, or the steps of the method according to the third aspect are implemented.

According to an eighth aspect, a chip is provided, where the chip includes a processor and a communication interface, the communication interface is coupled to the processor, and the processor is configured to run a program or instructions to implement the steps of the method according to the first aspect or the steps of the method according to the third aspect.

According to a ninth aspect, a computer program/program product is provided, where the computer program/program product is stored in a storage medium, and the computer program/program product is executed by at least one processor to implement the steps of the method according to the first aspect are implemented, or the steps of the method according to the third aspect.

### BRIEF DESCRIPTION OF DRAWINGS

FIG. 1 is a block diagram of a wireless communication system to which embodiments of this application are applicable;

FIG. 2 is a schematic diagram of interaction in augmented reality according to an embodiment of this application;

FIG. 3 is a schematic diagram of a 5G system according to an embodiment of this application;

FIG. 4a is a schematic diagram of a user plane protocol stack according to an embodiment of this application;

FIG. 4b is a schematic diagram of a control plane protocol stack according to an embodiment of this application;

FIG. 5 is a flowchart of an information transmission method according to an embodiment of this application;

FIG. 6 is a flowchart of another information transmission method according to an embodiment of this application;

FIG. 7 is a structural diagram of an information transmission apparatus according to an embodiment of this application;

FIG. 8 is a structural diagram of another information transmission apparatus according to an embodiment of this application;

FIG. 9 is a structural diagram of a communication device according to an embodiment of this application;

FIG. 10 is a structural diagram of a terminal according to an embodiment of this application; and

FIG. 11 is a structural diagram of a network-side device according to an embodiment of this application.

### DETAILED DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. Based on the embodiments in this application, all other embodiments obtained by ordinary people in this field belong to the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a long term evolution (LTE) or LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a new radio (NR) system is described for an illustration purpose, and NR terms are used in most of the following descriptions, although these technologies may also be applied to other applications than an NR system application, for example, the 6th generation (6G) communication system.

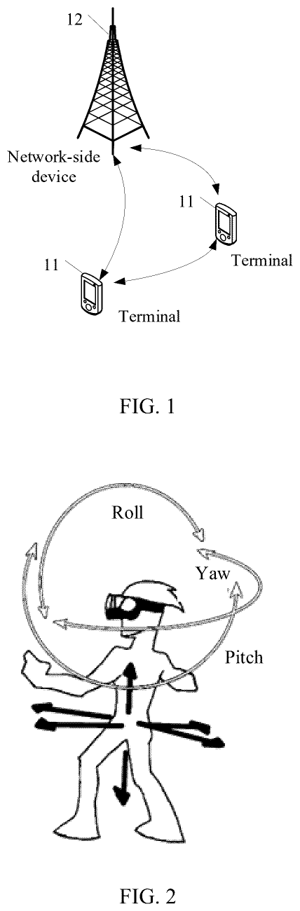

FIG. 1 illustrates a block diagram of a wireless communication system to which an embodiment of this application can be applied. The wireless communication system includes a terminal 11 and a network-side device 12. The terminal 11 may be a terminal-side device such as a mobile phone, a tablet computer, a laptop computer or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a specific type of the terminal 11 is not limited in the embodiments of this application. The network-side device 12 may include an access network device or a core network device, where the access network device may also be referred to as a radio access network device, a radio access network (RAN), a radio access network function, or a radio access network unit. The access network device may include a base station, a wireless local area network (WLAN) access point, a wireless fidelity Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (Local NEF, or L-NEF), a binding support function (BSF), an application function (AF), and the like. It should be noted that, in the embodiments of this application, a core network device in an NR system is used as an example for description, and a specific type of the core network device is not limited.

For ease of understanding, the following describes some content involved in the embodiments of this application:

### I. XR Service

XR refers to all real and virtual combined environments and human-computer interaction generated by computer technology and wearable devices. It includes representative forms such as augmented reality (AR), mixed reality (MR), virtual reality (VR), and their overlapping fields. The level of the virtual world ranges from partial sensory input to fully immersive virtual reality. A key aspect of XR is the extension of human experience, especially experiences related to presence (as represented by VR) and cognitive acquisition (as represented by AR).

For VR services, the uplink mainly involves transmission of densely packed small data packets. These small data packets can carry information such as gestures and controls, serving as input and reference for the presentation data on the downlink. The downlink mainly involves transmission of multimedia data such as video and audio, providing users with an immersive experience through timely reception and presentation of these multimedia data. Using downlink video data as an example, data packets arrive periodically or quasi-periodically, with data rates reaching tens or even hundreds of megabits per second (Mbps). The typical frame rate (FPS) is 60 or 120, and the interval between adjacent data packets is approximately 1/FPS seconds. These data generally need to be successfully transmitted within 10 ms over the air interface, with a required transmission success rate of no less than 99%, or even 99.9%.

For AR services, in addition to the transmission of dense small data packets, multimedia data such as video and audio may also be transmitted in the uplink. The service characteristics are similar to those of the downlink, generally with a relatively lower data rate, for example, up to tens of Mbps. The time limit for air interface transmission can also be relaxed, generally requiring successful transmission within 60 ms. The characteristics of downlink data transmission are basically consistent with those of VR services.

Users expect to interact and operate in augmented reality. As shown in FIG. 2, actions and interactions include motions, gestures, and body reactions. Therefore, the degree of freedom (DoF) describes the number of independent parameters used to define viewport movement in 3D space.

In XR application scenarios, users can obtain information on new viewpoint angles through actions such as turning their heads in a virtual reality experience. In this case, the XR user's head-turning action can be reported to the base station by sending an uplink signal. After receiving the uplink signal, the base station will schedule necessary downlink data for the XR user to use.

XR services mainly include video data, audio data, and some control signaling and special data that serve control functions. In wireless networks, XR service transmission mainly involves transmission and interaction of uplink and downlink video/audio data between user equipment (UE) and the wireless networks through new networks (such as LTE/NR). While transmitting the video and audio data itself, UE also needs to transmit, on the uplink, some control signaling with control functions and special data through the wireless network, to control generation, processing, and downlink wireless transmission of video and audio service data in XR services sent by the network for the UE.

These control information with control functions and special data include some service control data generated by an XR application encoder of the UE and control data information contained in service transmission protocol. For example:

From the application perspective, it may include but is not limited to the following information:

I frames or non-field of view (non-FOV) frames generated by a video encoder; and
user behavior data collected by sensors, such as pose/control data. The network can determine user behavior through reception of this data, such as the aforementioned user head-turning action, and adjust the video data content to be sent.

From the transmission protocol perspective, it can include the following information:
real-time transport protocol (RTP) acknowledgment (ACK) signaling for downlink audio/video service (transmission control protocol (TCP) feedback). Based on whether corresponding video/audio frames have been acknowledged by the UE, the network needs to determine whether to continue to send subsequent frames; and

RTP control protocol (RTCP) ACK signaling that is used to control control signaling of real-time data transmission and confirm real-time requirements and time synchronization of service data transmission.

The network usually needs to receive these pieces of control signaling that has a control function and special data from the UE, timely and reliably, to obtain transmission status of the current service and necessary control information. The application server needs to generate, based on such information, subsequent video and audio service data required for transmission and deliver it to the wireless network for processing and transmission, and finally sends these service data on the downlink to the UE.

### II. Buffer Status Report (BSR) Reporting

To facilitate the network side to perform uplink scheduling based on to-be-transmitted uplink data, the BSR reporting mechanism is introduced from LTE, allowing the UE to report the amount of to-be-transmitted uplink data for each logical channel group to the base station. This mechanism is basically retained in NR.

The granularity of BSR reporting is logical channel group (LCG), and each established logical channel can be configured with one corresponding logical channel group. NR supports configuring up to 8 logical channel groups for a single UE simultaneously.

The BSR can be triggered based on the following events:
new to-be-transmitted uplink data arrives at a logical channel of a logical channel group, and a priority of this logical channel is higher than those of logical channels that previously have to-be-transmitted uplink data, or none of the logical channels previously has to-be-transmitted uplink data; in this case, a regular BSR is triggered;
when organizing a new to-be-transmitted uplink transport block (TB), the number of padding bits in the new TB is greater than or equal to the number of bits occupied by (a single BSR media access control (MAC) control element (CE)+its corresponding subheader) (that is, the padding bits in the new to-be-transmitted TB can also accommodate bits corresponding to a single BSR MAC CE); in this case, a padding BSR is triggered;
a BSR retransmission timer (retxBSR-Timer) expires, and there is to-be-transmitted uplink data in at least one logical channel; in this case, a regular BSR is triggered; and
a BSR periodic timer (periodicBSR-Timer) expires; in this case, a periodic BSR is triggered.

When a regular BSR is triggered and there is no uplink resource for new transmission, the UE triggers an SR (Scheduling Request) to request a new uplink transmission resource from the network through PUCCH transmission or random access.

When a periodic BSR is triggered, the UE includes only one BSR MAC CE in a constructed uplink TB when there are new uplink transmission resources, but may not actively request the network for new uplink transmission resources by triggering an SR.

When a padding BSR is triggered, the UE directly includes one BSR MAC CE in the new uplink to-be-transmitted TB.

### III. Access Stratum (AS) Data Transmission Mechanism

Packet data convergence protocol (PDCP) layer and radio bearer (RB):
service data generated by the application layer (APP) of the UE is classified into different service data streams according to their corresponding QoS requirements, with each service data stream corresponding to the same or similar QoS requirements. In the NR system, the service data stream corresponds to one QoS flow; in the LTE system, the service data stream corresponds to an evolved packet system (EPS) bearer.

The service data may be delivered to the AS in the form of data packet, and is further mapped to one radio bearer in the AS based on its corresponding QoS flow (NR) or EPS bearer (LTE). One radio bearer includes one PDCP entity (PDCP protocol layer processing entity), one radio link control (RLC) entity (PDCP protocol layer processing entity) and a corresponding logical channel (located at the MAC protocol layer).

When one data packet delivered to the AS is mapped to one radio bearer, it may be delivered to the corresponding PDCP entity for processing in the form of a PDCP service data unit (SDU). The PDCP entity may generate one corresponding PDCP protocol data unit (PDU) for each arriving PDCP SDU, and sets one PDCP sequence number (SN) to indicate a transmission sequence corresponding to each PDCP SDU and its corresponding PDCP PDU in the PDCP entity. A value of the PDCP SN is set based on an order in which the PDCP SDU is delivered to the PDCP entity, with PDCP SDUs that arrive earlier being transmitted first. Specifically, the PDCP entity may maintain one internal variable, TX_NEXT, which represents the total number of PDCP PDUs transmitted by the PDCP entity and is used to set the value of the PDCP SN. It is initialized to 0 when the PDCP entity is established. Each time one PDCP SDU is delivered from the upper layer to the corresponding PDCP entity, the PDCP entity sets an SN of a PDCP PDU corresponding to the PDCP SDU to TX_NEXT and increments TX_NEXT by 1. After that, the PDCP entity adds a header file for each PDCP SDU and generates a corresponding PDCP PDU, which contains an SN value set for the PDCP PDU. The PDCP entity typically delivers the PDCP PDU, according to an order of SN values contained in the PDCP PDU, to the lower protocol layer (for example, RLC) for subsequent processing and transmission. SN is an ordinal number indicating a transmission order of each PDCP SDU.

The general principle is that a PDCP SDU reaching the PDCP entity earlier has a smaller SN value and is transmitted earlier.

### RLC Layer:

A PDCP PDU delivered from the PDCP entity to a corresponding RLC entity is treated as a to-be-transmitted RLC SDU and buffered within a buffer area of the UE, and then is further processed by the RLC entity. Specifically, when a logical channel corresponding to a specific RLC entity is allocated transmission resources (see the introduction to the MAC layer and logical channels below), the RLC entity will determine, based on the amount of data that can be accommodated by the allocated transmission resources and the amount of data of to-be-transmitted RLC SDUs in the buffer area, which RLC SDUs can be multiplexed into the allocated transmission resources for transmission.

For one or more RLC SDUs that the RLC entity has determined can be fully multiplexed into the allocated transmission resources, the RLC entity will individually add corresponding RLC headers for these RLC SDUs, generate corresponding RLC PDUs, and deliver them to the lower protocol layer (for example, MAC) for subsequent processing and transmission. However, after multiplexing of the foregoing complete RLC PDUs, if there are still some resources left, but they are not enough to multiplex one complete RLC SDU (that is, the amount of data that resources can support is less than the amount of data required for multiplexing the next RLC SDU), the RLC entity will perform segmentation processing, that is, add a header file to part of data of the next RLC SDU to be transmitted, generate an RLC PDU, and deliver it to the lower protocol layer for subsequent processing and transmission.

For such a segmented RLC SDU, the rest will still be kept in the buffer area of the UE, waiting for arrival of the next uplink transmission resource and transmission.

### MAC Layer and Logical Channel:

The RLC entity corresponding to each radio bearer further corresponds to one logical channel at the MAC layer. When the UE is allocated one uplink transmission resource grant (Uplink grant), the MAC entity of the UE further allocates these uplink transmission resources among multiple logical channels. Specifically, each logical channel corresponds to one logical channel priority, and the MAC entity of the UE, based on the resource allocation mechanism of logical channel prioritization (LCP), allocates available transmission resources of the current uplink transmission to each logical channel based on a descending order of logical channel priorities, corresponding to the amount of data that can be transmitted by each logical channel.

As mentioned above, based on the transmission resources allocated to each logical channel, the corresponding RLC entity delivers one or more RLC PDUs to a corresponding logical channel of the MAC layer. The MAC layer uses these RLC PDUs obtained from the RLC entity for each logical channel as to-be-transmitted MAC SDUs, adds MAC headers corresponding to the logical channel to form MAC sub-PDUs (subPDU) for the corresponding logical channel. The MAC sub-PDUs are then multiplexed onto the entire transmission resources and sent as data for uplink transmission of the logical channel. The MAC sub-PDUs of multiple logical channels are combined together to finally form one MAC PDU, which is used as a data packet of the current uplink transmission and is transmitted to the network through radio signals.

It should be noted that due to the segmentation processing performed by the RLC entity on the RLC SDU, as mentioned above, for uplink transmission resources obtained by each UE, the UE needs to first multiplex a remaining part of an RLC SDU segmented during a previous transmission and not yet fully transmitted onto available resources for transmission. After that, data packets corresponding to other subsequent RLC SDUs can be then transmitted.

Overall, in LTE and NR networks of related technologies, the UE typically adopts a “first arrived, first transmitted” principle for data of each radio bearer to implement the aforementioned uplink data processing and transmission process. Specifically, for each radio bearer, the UE processes data packets (for example, SDUs) based on the order of delivering the data packets to entities at each protocol layer, and delivers the processed data packets (for example, PDUs) in sequence to the subsequent protocol layer. That is, for a data packet delivered earlier to the AS, the corresponding PDCP entity assigns it a front PDCP sequence number (SN) value, ensuring that the data packet is processed first by the respective protocol layer and is multiplexed onto uplink resources for transmission first. Conversely, a data packet arriving later is assigned a back PDCP SN value, and is typically processed, multiplexed, and transmitted by the protocol layer after earlier arriving packets. This also means that for data packets mapped to each radio bearer, the UE finally implements a sequential transmission mechanism according to a sequence in which the data packets arrive at the AS.

This principle is mainly based on consideration of transmission delay: because transmission delay requirements of data in each radio bearer are basically the same in the wireless networks of related technologies, the AS of the UE is not allowed to obtain specific content of each data packet in the wireless networks of related technologies, and it is impossible to perform differentiated processing for each data packet. Therefore, from the perspective of delay, uplink processing, scheduling, and transmission of data packets based on their order of arrival is a relatively proper approach in related technologies.

### PDCP Layer Discard Timer:

Basic principle of DiscardTimer: a DRB discard timer, only available on DRB. The sending side starts a new timer for each SDU arriving from the upper layer, and discards the SDU upon timeout, preventing send buffer congestion, preventing congestion of a transmission buffer. A specific duration of this timer is configured by radio resource control (RRC) of the upper layer.

Specifically, when receiving a PDCP SDU delivered by the upper layer, the PDCP entity on the sending side starts one discard timer associated with this PDCP SDU.

When the discard timer associated with the PDCP SDU expires, or the PDCP SDU is successfully transmitted (that is, successful transmission is confirmed by using a PDCP status report), the PDCP entity on the sending side needs to discard the PDCP SDU and the corresponding PDCP data PDU. If the PDCP data PDU has been passed to the lower layer, the lower layer needs to be instructed to discard it.

For SRB, when the upper layer requests to discard one PDCP SDU, the PDCP entity needs to discard all stored PDCP SDUs and PDCP PDUs.

It can be understood that discarding one PDCP SDU that has been associated with PDCP SN may bring one SN gap in the transmitted PDCP data PDUs, which increases a corresponding PDCP re-ordering delay in the receiving PDCP entity. In this case, how to minimize the SN gap after the SDU is discarded will be guaranteed based on UE implementation.

### PDU Set:

A PDU set includes one or more PDUs, and the PDU carries a payload of one information element generated at the application layer (for example, a frame or a video segment of an XRM service). In some implementations, the application layer requires all PDUs in the PDU set to use corresponding information elements. In other implementations, when some PDUs are lost, the application layer can still resume part or all of information elements.

Data burst: data generated by an application in a short time, including PDUs from one or more PDU sets.

IV. 5G architecture

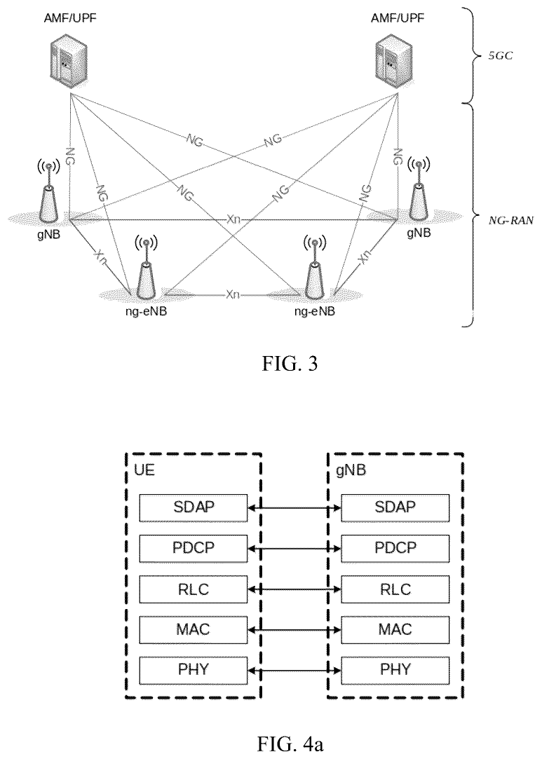

The 5G system includes an access network (AN) and a 5G core network (5GC). For an NSA (non-standalone network) scenario, 4G network elements also need to be considered, as shown in FIG. 3.

The AN includes the following two types:
gNB, which provides NR user plane and control plane protocol endpoints for UE; and
ng-eNB, which provides E-UTRA user plane and control plane protocol endpoints for UE.

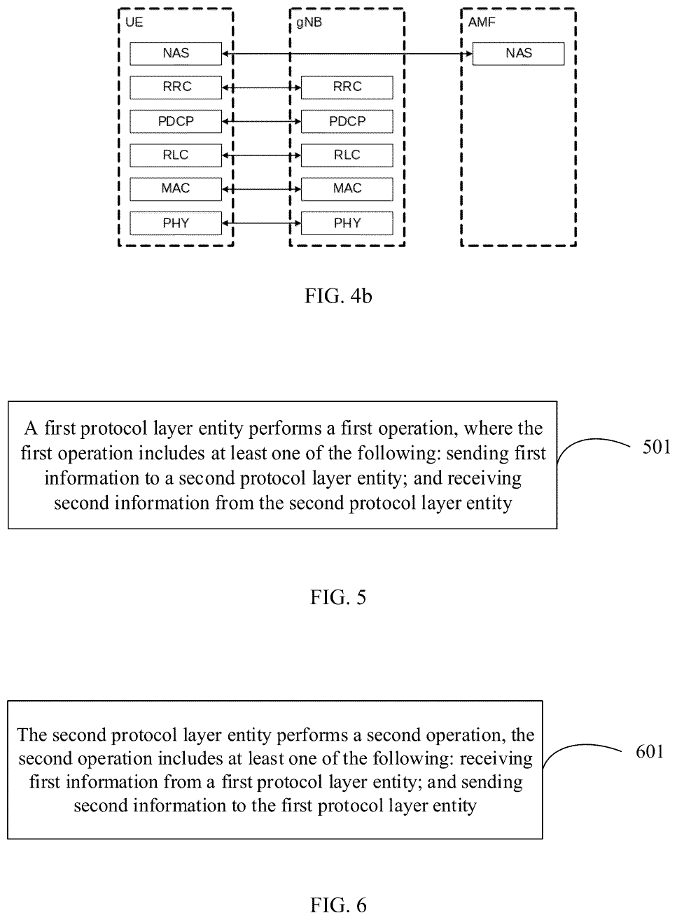

The air interface protocol stack of the 5G system may be shown in FIGS. 4a and 4b.

The following specifically describes the information transmission method provided in the embodiments of this application through specific embodiments and application scenarios thereof with reference to the accompanying drawings.

Referring to FIG. 5, FIG. 5 is a flowchart of an information transmission method according to an embodiment of this application. The method is applied to a first protocol layer entity. As shown in FIG. 5, the method includes the following steps.

Step 501: The first protocol layer entity performs a first operation, where the first operation includes at least one of the following:
sending first information to a second protocol layer entity, where the first information is used for requesting information about a data object associated with a data object of the first protocol layer entity from the second protocol layer entity, and the data object includes at least one of a data packet, a data packet group, and a service data unit SDU; and
receiving second information from the second protocol layer entity, where the second information is a first response message to the first information, or the second information includes related information of a data object of the second protocol layer entity; where
the first protocol layer entity and the second protocol layer entity are located in a same communication device.

In this embodiment, the first protocol layer entity and the second protocol layer entity may include, but are not limited to, at least one of the following: a PDCP entity, a service data adaptation protocol (SDAP) entity, a radio link control (RLC) entity, a media access control (MAC) entity, and a physical (PHY) entity.

It should be noted that the type of the second protocol layer entity is the same as that of the first protocol layer entity, for example, the first protocol layer entity is a first PDCP entity and the second protocol layer entity is a second PDCP entity. In addition, the second protocol layer entity and the first protocol layer entity are located in a same communication device, where the communication device may be a terminal or a network-side device, where the terminal may include but is not limited to the types of the terminal 11 listed above, and the network-side device includes but is not limited to the types of the network-side device 12 listed above.

It should also be noted that the data packet or data packet group of the first protocol layer entity can be understood as a data packet or data packet group mapped to the first protocol layer entity, or a data packet or data packet group associated with the first protocol layer entity, or a data packet or data packet group corresponding to the first protocol layer entity. The data packet or data packet group of the second protocol layer entity can be understood as a data packet or data packet group mapped to the second protocol layer entity, or a data packet or data packet group associated with the second protocol layer entity, or a data packet or data packet group corresponding to the second protocol layer entity.

The related information of the data object of the first protocol layer entity may include, but is not limited to, an identifier related to the data object of the first protocol layer entity, a status related to the data object of the first protocol layer entity, and the like. The related information of the data object of the second protocol layer entity may include, but is not limited to, an identifier related to the data object of the second protocol layer entity, a status related to the data object of the second protocol layer entity, and the like.

The data object associated with the data object of the first protocol layer entity may include, but is not limited to, at least one of the following: a data object belonging to a same group as the data object of the first protocol layer entity; a data object belonging to a same data packet group as the data object of the first protocol layer entity; a data object having a dependency relationship with the data object of the first protocol layer entity; and a data object having a correlation with the data object of the first protocol layer entity. For example, the related information of the data object associated with the data object of the first protocol layer entity may include an identifier related to the data object that is associated with the data object of the first protocol layer entity.

According to the information transmission method provided in this embodiment of this application, the first protocol layer entity performs a first operation, where the first operation includes at least one of the following: sending first information to a second protocol layer entity, where the first information is used for requesting information about a data object associated with a data object of the first protocol layer entity from the second protocol layer entity, and the data object includes at least one of a data packet, a data packet group, and a service data unit SDU; and receiving second information from the second protocol layer entity, where the second information is a first response message to the first information, or the second information includes related information of a data object of the second protocol layer entity; where the first protocol layer entity and the second protocol layer entity are located in a same communication device. This allows different protocol layer entities within the communication device to coordinate the processing of data packets or data packet groups, thereby improving efficiency of data processing in the communication device and reducing resource waste during the data processing process.

Optionally, the first information includes at least one of the following:
related information of a first data object, where the first data object is a data object of the first protocol layer entity, and the first data object includes at least one of a first data packet, a first data packet group, and a first SDU;
related information of a second data object, where the second data object is a data object associated with the first data object; and
first request information, where the first request information is used to request the second protocol layer entity to obtain a related status of the second data object.

The first SDU is specifically an SDU of the first protocol layer entity.

In this embodiment, the first data object may include part or all of data objects of the first protocol layer entity. For example, the first data object may include a problematic data object in the first protocol layer entity, a data object currently being processed, and the like.

In an implementation, the first protocol layer entity can transfer the related information of the data object of the first protocol layer entity to the second protocol layer entity, and correlation is determined and obtained by the second protocol layer entity. For example, the first protocol layer entity can transfer related information of a first data object to the second protocol layer entity, so that the second protocol layer entity can determine a data object associated with the first data object based on the related information of the first data object, and can process the data object associated with the first data object based on a status of the first data object, such as discarding or transmitting. In addition, the second protocol layer entity may also send a status related to the data object associated with the first data object and an identifier related to the data object associated with the first data object to the first protocol layer entity, and then the first protocol layer entity may perform data processing based on the status related to the data object associated with the first data object.

In another implementation, the correlation can be determined and obtained by the first protocol layer entity and transferred to the second protocol layer entity. Specifically, the first protocol layer entity can transfer the related information of the second data object to the second protocol layer entity, for example, an identifier related to the second data object, and then the second protocol layer entity can obtain a status related to the second data object based on the identifier related to the second data object and send the status related to the second data object to the first protocol layer entity. Further, the first protocol layer entity can perform data processing based on the status related to the second data object.

In yet another implementation, the first protocol layer entity may send first request information to the second protocol layer entity for requesting the second protocol layer entity to obtain the status related to the second data object, so that the second protocol layer entity can return the status related to the second data object of the second protocol layer entity to the first protocol layer entity in response to the first request information and, and then the first protocol layer entity can perform data processing based on the status related to the second data object. The status related to the second data object may include at least one of the following: a status of the second data object, a status of an SDU corresponding to the second data object, and a status of a PDU corresponding to the second data object.

Optionally, the second data object includes at least one of a second data packet and a second data packet group.

The second data packet includes at least one of the following:
a data packet associated with the first data packet;
a data packet associated with a data packet group to which the first data packet belongs;
a data packet associated with the first data packet group;
a data packet associated with a data packet corresponding to the first SDU;
a data packet associated with a data packet group corresponding to the first SDU; and
a data packet associated with a data packet group to which a data packet corresponding to the first SDU belongs;
and/or
the second data packet group includes at least one of the following:
a data packet group associated with the first data packet;
a data packet group associated with the data packet group to which the first data packet belongs;
a data packet group associated with the first data packet group;
a data packet group associated with a data packet corresponding to the first SDU;
a data packet group associated with a data packet group corresponding to the first SDU; and
a data packet group associated with a data packet group to which a data packet corresponding to the first SDU belongs.

Optionally, the related information of the first data object includes at least one of the following:
an identifier related to the first data object and a status related to the first data object;
and/or
the related information of the second data object includes an identifier related to the second data object.

Optionally, the identifier related to the first data object includes at least one of the following:
an identifier (that is, ID) of the first data packet;
a sequence number (SN) of the first data packet;
a quality of service QoS flow identifier (that is, a QoS flow ID) corresponding to the first data packet;
an identifier (that is, ID) of a protocol layer corresponding to the first data packet;
an identifier (that is, ID) of the first data packet group;
an SN of the first data packet group;
a QoS flow identifier corresponding to the first data packet group;
an identifier of a protocol layer corresponding to the first data packet group;
an identifier of a data packet corresponding to the first SDU;
an SN of a data packet corresponding to the first SDU;
a QoS flow identifier corresponding to a data packet corresponding to the first SDU;
an identifier of a protocol layer corresponding to a data packet corresponding to the first SDU;
an identifier of a data packet group corresponding to the first SDU;
an SN of a data packet group corresponding to the first SDU;
a QoS flow identifier corresponding to a data packet group corresponding to the first SDU; and
an identifier of a protocol layer corresponding to a data packet group corresponding to the first SDU.

Optionally, the identifier of the protocol layer includes at least one of the following:
a PDCP SN;
a data radio bearer (DRB) identifier (that is, ID);
an RLC bearer identifier (that is, RLC bearer ID); and
a MAC logical channel identifier (that is, MAC LCH ID).

Optionally, the status related to the first data object includes at least one of the following:
a status of the first data packet;
a status of the first data packet group;
a status of an SDU corresponding to the first data packet;
a status of an SDU corresponding to the first data packet group;
a status of the first SDU;
a status of a data packet corresponding to the first SDU; and
a status of a data packet group corresponding to the first SDU.

Optionally, the status of the data packet or the data packet group includes at least one of the following:
the data packet or data packet group has been correctly transmitted;
the data packet or data packet group has not been correctly transmitted;
an SDU corresponding to the data packet or the data packet group has not been correctly transmitted;
the data packet or data packet group has been delivered to a lower layer or an upper layer;
the data packet or data packet group has not been delivered to the lower layer or the upper layer;
the SDU corresponding to the data packet or the data packet group has not been delivered to the lower layer or the upper layer;
the data packet or data packet group has been discarded;
the data packet or data packet group has not been discarded;
an SDU corresponding to the data packet or the data packet group has been discarded;
the SDU corresponding to the data packet or the data packet group has not been discardrd;
a delay of the data packet or a delay of the data packet group exceeds a preset time;
the delay of the data packet or the delay of the data packet group does not exceed the preset time;
a discard timer corresponding to the SDU corresponding to the data packet or the data packet group has expired;
the discard timer corresponding to the SDU corresponding to the data packet or the data packet group has not expired;
a remaining delay corresponding to the data packet or the data packet group is less than a preset threshold; and
the remaining delay corresponding to the data packet or the data packet group is greater than or equal to the preset threshold.

The preset time may include but is not limited to at least one of the following: a packet delay budget (PDB) or a remaining PDB, and a PDU set delay budget (PSDB) or a remaining PSDB. A value of the preset threshold can be configured by the network-side device or specified by the protocol. For example, the value of the preset threshold may be 0. The remaining delay may include but is not limited to a remaining PDB, a remaining PSDB, and the like.

Optionally, the status of the SDU includes at least one of the following:
the SDU has been correctly transmitted;
the SDU has not been correctly transmitted;
a data packet or data packet group corresponding to the SDU has not been correctly transmitted;
the data packet or data packet group corresponding to the SDU has been delivered to the lower layer or the upper layer;
the data packet or data packet group corresponding to the SDU has not been delivered to the lower layer or the upper layer;
the SDU has been delivered to the lower layer or the upper layer;
the SDU has not been delivered to the lower layer or the upper layer;
the SDU has been discarded;
the SDU has not been discarded;
the data packet or data packet group corresponding to the SDU has been discarded;
the data packet or data packet group corresponding to the SDU has not been discarded;
a delay of the SDU exceeds a preset time;
the delay of the SDU does not exceed the preset time;
a discard timer corresponding to the data packet or the data packet group corresponding to the SDU has expired;
the discard timer corresponding to the data packet or the data packet group corresponding to the SDU has not expired;
a remaining delay corresponding to the SDU is less than a preset threshold; and
the remaining delay corresponding to the SDU is greater than or equal to the preset threshold.

For the preset time, the preset threshold, and the remaining delay in this embodiment, refer to the related description of the previous embodiments. Details are not repeated here.

Optionally, the identifier related to the second data object includes at least one of the following:
an identifier of the second data object;
an SN of the second data object;
a QoS flow identifier corresponding to the second data object; and
an identifier of a protocol layer corresponding to the second data object.

Optionally, the first data packet includes at least one of the following: a data packet in the first protocol layer entity, a problematic data packet, a data packet corresponding to a problematic SDU, a data packet corresponding to an SDU in the first protocol layer entity, and a data packet corresponding to the first SDU;
and/or
the first data packet group includes at least one of the following: a data packet group in the first protocol layer entity, a problematic data packet group, a data packet group corresponding to a problematic SDU, a data packet group corresponding to an SDU in the first protocol layer entity, and a data packet group corresponding to the first SDU;
and/or
the first SDU includes at least one of the following: a problematic SDU, an SDU in the first protocol layer entity, an SDU corresponding to a problematic data packet, an SDU corresponding to a problematic data packet group, an SDU corresponding to a data packet in the first protocol layer entity, and an SDU corresponding to a data packet group in the first protocol layer entity.

Optionally, the problematic data packet or data packet group includes at least one of the following:
a data packet or data packet group that has not been correctly transmitted;
a data packet or data packet group expected not to be correctly transmitted;
a data packet or data packet group corresponding to an SDU that has not been correctly transmitted;
a data packet or data packet group corresponding to an SDU expected not to be correctly transmitted;
a data packet or data packet group that has not been delivered to the lower layer or upper layer;
a data packet or data packet group expected not to be delivered to the lower layer or upper layer;
a data packet or data packet group corresponding to an SDU that has not been delivered to the lower layer or upper layer;
a data packet or data packet group corresponding to an SDU expected not to be delivered to the lower layer or upper layer;
a data packet or data packet group that has been discarded;
a data packet or data packet group expected to be discarded;
a data packet or data packet group corresponding to an SDU that has been discarded;
a data packet or data packet group corresponding to an SDU expected to be discarded;
a data packet or data packet group with a delay exceeding a preset time;
a data packet or data packet group expected to have a delay exceeding a preset time;
a data packet or data packet group corresponding to an SDU with a delay exceeding a preset time;
a data packet or data packet group corresponding to an SDU expected to have a delay exceeding a preset time;
a data packet or data packet group with a corresponding discard timer that has expired;
a data packet or data packet group expected to have a corresponding discard timer expire;
a data packet or data packet group corresponding to an SDU with a corresponding discard timer that has expired;
a data packet or data packet group corresponding to an SDU expected to have a corresponding discard timer expire;
a data packet or data packet group corresponding to an SDU with a remaining delay less than a preset threshold; and
a data packet or data packet group corresponding to an SDU expected to have a remaining delay less than the preset threshold.

Optionally, the problematic SDU includes at least one of the following:
an SDU that has not been correctly transmitted;
an SDU expected not to be correctly transmitted;
an SDU corresponding to a data packet or data packet group that has not been correctly transmitted;
an SDU corresponding to a data packet or data packet group expected not to be correctly transmitted;
an SDU that has not been delivered to the lower layer or upper layer;
an SDU expected not to be delivered to the lower layer or upper layer;
an SDU corresponding to a data packet or data packet group that has not been delivered to the lower layer or upper layer;
an SDU corresponding to a data packet or data packet group expected not to be delivered to the lower layer or upper layer;
an SDU that has been discarded;
an SDU expected to be discarded;
an SDU corresponding to a data packet or data packet group that has been discarded;
an SDU corresponding to a data packet or data packet group expected to be discarded;
an SDU with a delay exceeding a preset time;
an SDU expected to have a delay exceeding a preset time;
an SDU corresponding to a data packet or data packet group with a delay exceeding a preset time;
an SDU corresponding to a data packet or data packet group expected to have a delay exceeding a preset time;
an SDU with a corresponding discard timer that has expired;
an SDU expected to have a corresponding discard timer expire;
an SDU corresponding to a data packet or data packet group with a corresponding discard timer that has expired;
an SDU corresponding to a data packet or data packet group expected to have a corresponding discard timer expire;
an SDU corresponding to a data packet or data packet group with a remaining delay less than a preset threshold;
an SDU corresponding to a data packet or data packet group expected to have a remaining delay less than the preset threshold;
an SDU expected to have a remaining delay less than the preset threshold; and
an SDU expected to have a remaining delay less than the preset threshold.

Optionally, the remaining delay of the data packet or data packet group includes at least one of the following:
a remaining packet delay budget PDB or a remaining protocol data unit set delay budget PSDB of the data packet or data packet group;
a remaining PDB or a remaining PSDB of the data packet or data packet group in the communication device or at the first protocol layer; and
a remaining delay requirement of the data packet or data packet group in the communication device or at the second protocol layer.

In this embodiment, the first protocol layer may include, but is not limited to, a PDCP layer, an RLC layer, a MAC or PHY layer, and the like. The second protocol layer may include, but is not limited to, a PDCP layer, an RLC layer, a MAC or PHY layer, and the like.

Optionally, the preset time includes at least one of the following: a PDB or a remaining PDB, and a PSDB or a remaining PSDB.

Optionally, the PDB or the PSDB is a delay requirement of a data object of the communication device;
or,
the PDB or the PSDB is a delay requirement of a data object of the communication device in a preset node, and the communication device is a terminal.

The preset node may include but is not limited to RAN or core network (CN), that is, the PDB may be a RAN PDB or a CN PDB, and the PSDB may be a RAN PSDB or a CN PSDB.

Optionally, the first response message includes at least one of the following:
first acknowledgment information, where the first acknowledgment information is used to indicate whether the second protocol layer entity has received the first information, or the first acknowledgment information is used to indicate whether the second protocol layer entity has not received the first information;
an identifier related to a third data object, where the third data object includes at least part of data objects in the first data object;
an identifier related to a fourth data object, where the fourth data object includes at least part of data objects associated with the first data object;
a status related to the fourth data object;
an identifier related to a fifth data object, where the fifth data object includes at least part of data objects in the second data object; and
a status related to the fifth data object.

For the first data object and the second data object in this embodiment, refer to the related descriptions of the previous embodiments. Details are not repeated here.

For example, the fourth data object or the fifth data object may include at least one of the following:
a data packet associated with the first data packet;
a data packet associated with a data packet group to which the first data packet belongs;
a data packet associated with the first data packet group;
a data packet associated with a data packet corresponding to the first SDU;
a data packet associated with a data packet group corresponding to the first SDU; and
a data packet associated with a data packet group to which a data packet corresponding to the first SDU belongs;
a data packet group associated with the first data packet;
a data packet group associated with the data packet group to which the first data packet belongs;
a data packet group associated with the first data packet group;
a data packet group associated with a data packet corresponding to the first SDU;
a data packet group associated with a data packet group corresponding to the first SDU; and
a data packet group associated with a data packet group to which a data packet corresponding to the first SDU belongs.

For example, the identifier related to the fourth data object or the fifth data object includes at least one of the following:
an identifier of the fourth data object or the fifth data object;
an SN of the fourth data object or the fifth data object;
a QoS flow identifier corresponding to the fourth data object or the fifth data object; and
an identifier of a protocol layer corresponding to the fourth data object or the fifth data object.

For example, the status related to the fourth data object or the fifth data object includes at least one of the following:
a status of the fourth data object or the fifth data object;
a status of an SDU corresponding to the fourth data object or the fifth data object; and
a status of a PDU corresponding to the fourth data object or the fifth data object;

The following describes this embodiment with examples:

In case 1, the second protocol layer entity may feed back one piece of acknowledgment information to the first protocol layer entity, which is used to indicate whether the second protocol layer entity has received the first information or has not received the first information.

In case 2, after receiving the first information, the second protocol layer entity may feed back at least part of identifiers related to data objects carried in the first information to the first protocol layer entity, for example, feed back the identifier related to the third data object and/or the identifier related to the fifth data object to the first protocol layer entity, where the third data object may include part or all of data objects in the first data object and the fifth data object may include part or all of data objects in the second data object.

In case 3, in a case that the first information is received, if the first information carries only the related information of the first data object, the second protocol layer entity may determine a data object associated with the first data object based on the first data object, and may feed back related information of at least part (that is, the fourth data object) of data objects associated with the first data object to the first protocol layer entity; if the first information carries the identifier related to the second data object, statuses related to at least part of data objects in the second data object (that is, the fifth data object) can be fed back to the first protocol layer entity.

Optionally, the related information of the data object of the second protocol layer entity includes at least one of the following:
related information of a sixth data object, where the sixth data object is a data object of the second protocol layer entity, and the sixth data object includes at least one of a third data packet and a third data packet group; and
related information of a seventh data object, where the seventh data object is a data object associated with the sixth data object.

The following describes this embodiment with examples:

In case 1, the second protocol layer entity sends the related information of the data object (that is, a sixth data object) of the second protocol layer entity to the first protocol layer entity, for example, an identifier and a status related to the sixth data object, so that the first protocol layer entity can determine a data object related to the sixth data object based on the identifier related to the sixth data object, and may feed back an identifier and status related to the data object related to the sixth data object to the second protocol layer entity. In addition, the first protocol layer entity can also process the data object of the first protocol layer entity based on the status related to the sixth data object.

In case 2, the second protocol layer entity sends the related information of the data object (that is, a seventh data object) associated with the data object of the second protocol layer entity to the first protocol layer entity, for example, an identifier related to the seventh data object, so that the first protocol layer entity can obtain a status related to the seventh data object based on the identifier related to the seventh data object, and may feed back the status related to the seventh data object to the second protocol layer entity.

In case 3, the second protocol layer entity sends the related information of the data object (that is, the sixth data object) of the second protocol layer entity and the related information of the data object (that is, the seventh data object) of the second protocol layer entity to the first protocol layer entity, so that the first protocol layer entity can obtain the status related to the seventh data object based on the identifier related to the seventh data object, and may feed back the status related to the seventh data object to the second protocol layer entity. In addition, the first protocol layer entity can also process the data object of the first protocol layer entity based on the status related to the sixth data object.

Optionally, the related information of the sixth data object includes at least one of the following: an identifier related to the sixth data object and a status related to the sixth data object;
and/or
the related information of the seventh data object includes an identifier related to the seventh data object.

Optionally, the identifier related to the sixth data object includes at least one of the following:
an identifier of the third data packet;
an SN of the third data packet;
an identifier of a data packet group to which the third data packet belongs;
an SN of the data packet group to which the third data packet belongs;
a QoS flow identifier corresponding to the third data packet;
an identifier of a protocol layer corresponding to the third data packet;
an identifier of the third data packet group;
an SN of the third data packet group;
a QoS flow identifier corresponding to the third data packet group; and
an identifier of a protocol layer corresponding to the third data packet group.

Optionally, the status related to the sixth data object includes at least one of the following:
the sixth data object has been correctly transmitted;
the sixth data object has not been correctly transmitted;
an SDU corresponding to the sixth data object has not been correctly transmitted;
a remaining data packet or data packet group of the sixth data object;
the sixth data object has been delivered to the lower layer or the upper layer;
the sixth data object has not been delivered to the lower layer or the upper layer;
the SDU corresponding to the sixth data object has not been delivered to the lower layer or the upper layer;
the sixth data object has been discarded;
the sixth data object has not been discarded;
the SDU corresponding to the sixth data object has been discarded;
the SDU corresponding to the sixth data object has not been discarded;
a delay of the sixth data object exceeds a preset time;
the delay of the sixth data object does not exceed the preset time;
a discard timer corresponding to the SDU corresponding to the sixth data object has expired;
the discard timer corresponding to the SDU corresponding to the sixth data object has not expired; and
a remaining delay corresponding to the sixth data object is less than a preset threshold.

Optionally, the seventh data object includes at least one of a fourth data packet and a fourth data packet group, and the identifier related to the seventh data object includes at least one of the following:
an identifier of the fourth data packet;
an SN of the fourth data packet;
an identifier of a data packet group to which the fourth data packet belongs;
an SN of the data packet group to which the fourth data packet belongs;
a QoS flow identifier corresponding to the fourth data packet;
an identifier of a protocol layer corresponding to the fourth data packet;
an identifier of the fourth data packet group;
an SN of the fourth data packet group;
the QoS flow identifier corresponding to the fourth data packet group; and
an identifier of a protocol layer corresponding to the fourth data packet group.

Optionally, the sixth data object includes at least one of the following:
a data object currently being processed;
a data object corresponding to an SDU currently being processed;
a data object that has not been correctly transmitted;
a data object corresponding to an SDU that has not been correctly transmitted;
a data object that has not been delivered to the lower layer or upper layer;
a data object corresponding to an SDU that has not been delivered to the lower layer or upper layer;
a data object that has been discarded;
a data object corresponding to an SDU that has been discarded;
a data object with a delay exceeding a preset time;
a data object corresponding to an SDU with a delay exceeding a preset time;
a data object with a discard timer that has expired;
a data object corresponding to an SDU with a discard timer that has expired;
a data object with a remaining delay less than a preset threshold; and
a data object corresponding to an SDU with a remaining delay less than preset threshold.

Optionally, the seventh data object includes at least one of the following:
a data packet associated with the third data packet;
a data packet group associated with the third data packet;
a data packet associated with a data packet group to which the third data packet belongs;
a data packet group associated with a data packet group to which the third data packet belongs;
a data packet associated with the third data packet group; and
a data packet group associated with the third data packet group.

Optionally, the sending, by the first protocol layer entity, the first information to the second protocol layer entity includes:
in a case that a first condition is met, sending, by the first protocol layer entity, the first information to the second protocol layer entity; where
the first condition includes at least one of the following:
first indication information sent by a network-side device has been received, where the first indication information is used to indicate the first protocol layer entity to send the first information to the second protocol layer entity;
second indication information sent by an upper layer of the first protocol layer entity has been received, where the second indication information is used to indicate the first protocol layer entity to send the first information to the second protocol layer entity;
a first request message sent by a first target protocol layer entity has been received, where the first request message is used for requesting the first protocol layer entity to send the first information to the second protocol layer entity;
a data packet or data packet group has arrived at the first protocol layer entity;
an upper layer data packet has arrived at the first protocol layer entity;
the first protocol layer entity has delivered a data packet or a data packet group or a PDCP protocol data unit PDU or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded;
an SDU corresponding to the data packet or the data packet group has been discarded;
the SDU corresponding to the data packet or the data packet group has not been discarded;
the data packet or data packet group corresponding to the SDU has been discarded;
the data packet or data packet group corresponding to the SDU has not been discarded;
a delay of the data packet, the data packet group, or the SDU exceeds a preset time;
a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; and
the remaining delay corresponding to the data packet, the data packet group, or the SDU is greater than or equal to the preset threshold.

For the data packet or data packet group reaching the first protocol layer entity, data packets may be divided from the service perspective, for example, the data packet or data packet group may be a PDU, a PDU set, or the like.

For the upper layer data packet or data packet group reaching the first protocol layer entity, data packets may be divided from the perspective of the upper-layer protocol, for example, the upper layer data packet or data packet group may be an SDAP PDU, an IP packet, or the like.

Optionally, after the performing, by a first protocol layer entity, a first operation, the method further includes:
sending, by the first protocol layer entity, third information to the second protocol layer entity, where the third information is a response message to the second information.

Optionally, the third information includes at least one of the following:
second acknowledgment information, where the second acknowledgment information is used to indicate whether the first protocol layer entity has received the second information, or the second acknowledgment information is used to indicate whether the first protocol layer entity has not received the second information;
an identifier related to an eighth data object, where the eighth data object includes at least one of the following: at least part of data objects in the third data object, at least part of data objects in the fourth data object, at least part of data objects in the fifth data object, at least part of data objects in the sixth data object, and at least part of data objects in the seventh data object;
an identifier related to a ninth data object, where the ninth data object is a data object related to the eighth data object; and
an identifier related to a tenth data object, where the tenth data object is a data object on which target processing is performed based on the second information.

For the third data object, the fourth data object, the fifth data object, the sixth data object and the seventh data object in this embodiment, refer to the related descriptions of the previous embodiments. Details are not repeated here.

The following describes this embodiment with examples:

In case 1, the first protocol layer entity may feed back one piece of acknowledgment information to the second protocol layer entity, which is used to indicate whether the first protocol layer entity has received the second information or has not received the second information.

In case 2, in a case that the second information is received, the first protocol layer entity may feed back identifiers related to at least part (that is, an eighth data object) of data objects carried in the second information to the second protocol layer entity.

In case 3, in a case that the second information is received, the first protocol layer entity may feed back identifiers related to data objects (that is, a ninth data object) that are associated with at least part (that is, the eighth data object) of data objects carried in the second information to the second protocol layer entity.

In case 4, in a case that the second information is received, the first protocol layer entity may perform target processing on at least part of data objects of the first protocol layer entity based on the second information, for example, performing target processing on the associated data objects based on a status of the data object of the second protocol layer entity carried in the second information, and feed back the data object on which target processing is performed based on the second information to the second protocol layer entity.

Optionally, the target processing includes at least one of the following: discarding, not discarding, transmitting, not transmitting, delivering to the upper layer or lower layer, and not delivering to the upper layer or lower layer.

Optionally, the sending, by the first protocol layer entity, the third information to the second protocol layer entity includes:
in a case that a second condition is met, sending, by the first protocol layer entity, the third information to the second protocol layer entity; where
the second condition includes at least one of the following:
third indication information sent by the network-side device has been received, where the third indication information is used to indicate the first protocol layer entity to send the third information to the second protocol layer entity;
fourth indication information sent by the upper layer has been received, where the fourth indication information is used to indicate the first protocol layer entity to send the third information to the second protocol layer entity;
a second request message sent by a second target protocol layer entity has been received, where the second request message is used for requesting the first protocol layer entity to send the third information to the second protocol layer entity;
a data packet or data packet group has arrived at the first protocol layer entity;
an upper layer data packet has arrived at the first protocol layer entity;
the first protocol layer entity is processing a data packet or a data packet group;
the first protocol layer entity has delivered a data packet or a data packet group or a PDCP PDU or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded;
an SDU corresponding to the data packet or the data packet group has been discarded;
the SDU corresponding to the data packet or the data packet group has not been discarded;
the data packet or data packet group corresponding to the SDU has been discarded;
the data packet or data packet group corresponding to the SDU has not been discarded;
a delay of the data packet, the data packet group, or the SDU exceeds a preset time;
a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; and
the remaining delay corresponding to the data packet, the data packet group, or the SDU is greater than or equal to the preset threshold.

Optionally, before the performing, by a first protocol layer entity, a first operation, the method further includes:
receiving, by the first protocol layer entity, fourth information from the upper layer or the lower layer, where the fourth information is used to request the first protocol layer entity to send the first information to the second protocol layer entity.

In this embodiment, the upper layer or the lower layer of the first protocol layer entity can control the first protocol layer entity to send the first information to the second protocol layer entity. The upper layer can be understood as the upper layer of the first protocol layer entity, and the lower layer can be understood as the lower layer of the first protocol layer entity.

Optionally, the fourth information may include at least one of the following: related information of the data object of the first protocol layer entity, for example, at least one of an identifier and a status related to the data object of the first protocol layer entity; the related information of the data object associated with the data object of the first protocol layer entity, for example, an identifier related to the data object associated with the data object of the first protocol layer entity.

Optionally, the fourth information includes at least one of the following:
related information of the first data object;
related information of the second data object; and
second request information, where the second request information is used for requesting the first protocol layer entity to obtain a status related to the second data object from the second protocol layer entity.

In this embodiment, for the related information of the first data object, the related information of the second data object, and the status related to the second data object, refer to the related descriptions of the previous embodiments. Details are not repeated here.

Optionally, after the performing, by a first protocol layer entity, a first operation, the method further includes:
sending, by the first protocol layer entity, fifth information to the upper layer or the lower layer; where
the fifth information includes at least one of the following:
third acknowledgment information, where the third acknowledgment information is used to indicate whether the first protocol layer entity has received the fourth information, or the third acknowledgment information is used to indicate whether the first protocol layer entity has not received the fourth information;
an identifier related to an eleventh data object, where the eleventh data object includes at least one of the following: at least part of data objects in the third data object, at least part of data objects in the fourth data object, at least part of data objects in the fifth data object, at least part of data objects in the sixth data object, and at least part of data objects in the seventh data object;
an identifier related to a twelfth data object, where the twelfth data object is a data object related to the eleventh data object; and
an identifier related to a thirteenth data object, where the thirteenth data object is a data object on which target processing is performed in response to the second information.

For the third data object, the fourth data object, the fifth data object, the sixth data object and the seventh data object in this embodiment, refer to the related descriptions of the previous embodiments. Details are not repeated here.

Optionally, the performing, by a first protocol layer entity, a first operation includes:
in a case that the communication device receive first configuration information from the network-side device, the first protocol layer entity performs the first operation, where the communication device is a terminal, and the first configuration information is used to indicate at least one of the following: the first protocol layer entity sends the first information to the second protocol layer entity, and the second protocol layer entity sends the second information to the first protocol layer entity.

For a protocol layer entity whose first protocol layer entity is a terminal, in a case that the terminal can receive the first configuration information from the network-side device, the terminal sends the first information to the second protocol layer entity through the first protocol layer entity, where the first configuration information may be static configuration information, that is, the network-side device controls whether to coordinate data processing between different protocol layer entities of the terminal. This can improve accuracy and flexibility of coordination control between different protocol layer entities of the terminal.

Optionally, the data object associated with the data object of the first protocol layer entity includes at least one of the following:
a data object belonging to a same group as the data object of the first protocol layer entity;
a data object belonging to a same data packet as the data object of the first protocol layer entity;
a data object having a dependency relationship with the data object of the first protocol layer entity; and
a data object having a correlation with the data object of the first protocol layer entity.

Optionally, the upper layer includes at least one of the following: non-access stratum (NAS), SDAP, PDCP, RLC, and MAC.

Optionally, the lower layer includes at least one of the following: access stratum (AS), PDCP, RLC, MAC, and physical layer (PHY).

Optionally, the data packet includes at least one of the following: PDCP SDU, PDCP PDU, data in a PDCP buffer, data packet corresponding to RLC bearer, data packet corresponding to MAC SDU, data packet corresponding to MAC PDU, PDU, PDU set (that is, PDU set), burst, frame, slice, picture, group of picture (GOP), PDU set group (that is, group of PDU set), PDU group (that is, group of PDU), and IP packet (that is, IP packet).

Optionally, the data packet group includes at least one of the following: PDU set group (that is, PDU set group), PDU set, burst, frame, slice, picture, GOP, PDU set group, PDU group, IP packet, at least two data packets, upper layer data packet, and data packet corresponding to QOS flow.

It should be noted that the foregoing implementations of this embodiment of this application can be properly combined according to actual requirements.

Referring to FIG. 6, FIG. 6 is a flowchart of an information transmission method according to an embodiment of this application. The method is applied to a second protocol layer entity. As shown in FIG. 6, the method includes the following steps.

Step 601: The second protocol layer entity performs a second operation, the second operation includes at least one of the following:
receiving first information from a first protocol layer entity, where the first information is used for requesting information about a data object associated with a data object of the first protocol layer entity from the second protocol layer entity, and the data object includes at least one of a data packet, a data packet group, and a service data unit SDU; and
sending second information to the first protocol layer entity, where the second information is a first response message to the first information, or the second information includes related information of a data object of the second protocol layer entity; where the first protocol layer entity and the second protocol layer entity are located in a same communication device.

Optionally, the first information includes at least one of the following:
related information of a first data object, where the first data object is a data object of the first protocol layer entity, and the first data object includes at least one of a first data packet, a first data packet group, and a first SDU;
related information of a second data object, where the second data object is a data object associated with the first data object; and
first request information, where the first request information is used to request the second protocol layer entity to obtain a related status of the second data object.

Optionally, the second data object includes at least one of a second data packet and a second data packet group.

The second data packet includes at least one of the following:
a data packet associated with the first data packet;
a data packet associated with a data packet group to which the first data packet belongs;
a data packet associated with the first data packet group;
a data packet associated with a data packet corresponding to the first SDU;
a data packet associated with a data packet group corresponding to the first SDU; and
a data packet associated with a data packet group to which a data packet corresponding to the first SDU belongs;
and/or
the second data packet group includes at least one of the following:
a data packet group associated with the first data packet;
a data packet group associated with the data packet group to which the first data packet belongs;
a data packet group associated with the first data packet group;
a data packet group associated with a data packet corresponding to the first SDU;
a data packet group associated with a data packet group corresponding to the first SDU; and
a data packet group associated with a data packet group to which a data packet corresponding to the first SDU belongs.

Optionally, the related information of the first data object includes at least one of the following: an identifier related to the first data object and a status related to the first data object;
and/or
the related information of the second data object includes an identifier related to the second data object.

Optionally, the identifier related to the first data object includes at least one of the following:
an identifier of the first data packet;
a sequence number SN of the first data packet;
a quality of service QoS flow identifier corresponding to the first data packet;
an identifier of a protocol layer corresponding to the first data packet;
an identifier of the first data packet group;
an SN of the first data packet group;
a QoS flow identifier corresponding to the first data packet group;
an identifier of a protocol layer corresponding to the first data packet group;
an identifier of a data packet corresponding to the first SDU;
an SN of a data packet corresponding to the first SDU;
a QoS flow identifier corresponding to a data packet corresponding to the first SDU; an identifier of a protocol layer corresponding to a data packet corresponding to the first SDU;
an identifier of a data packet group corresponding to the first SDU;
an SN of a data packet group corresponding to the first SDU;
a QoS flow identifier corresponding to a data packet group corresponding to the first SDU; and
an identifier of a protocol layer corresponding to a data packet group corresponding to the first SDU.

Optionally, the identifier of the protocol layer includes at least one of the following:
a packet data convergence protocol PDCP SN;
a data radio bearer DRB identifier;
a radio link control RLC bearer identifier; and
a media access control MAC logical channel identifier.

Optionally, the status related to the first data object includes at least one of the following:
a status of the first data packet;
a status of the first data packet group;
a status of an SDU corresponding to the first data packet;
a status of an SDU corresponding to the first data packet group;
a status of the first SDU;
a status of a data packet corresponding to the first SDU; and
a status of a data packet group corresponding to the first SDU.

Optionally, the identifier related to the second data object includes at least one of the following:
an identifier of the second data object;
an SN of the second data object;
a QoS flow identifier corresponding to the second data object; and
an identifier of a protocol layer corresponding to the second data object.

Optionally, the status of the data packet or the data packet group includes at least one of the following:
the data packet or data packet group has been correctly transmitted;
the data packet or data packet group has not been correctly transmitted;
an SDU corresponding to the data packet or the data packet group has not been correctly transmitted;
the data packet or data packet group has been delivered to a lower layer or an upper layer;
the data packet or data packet group has not been delivered to the lower layer or the upper layer;
the SDU corresponding to the data packet or the data packet group has not been delivered to the lower layer or the upper layer;
the data packet or data packet group has been discarded;
the data packet or data packet group has not been discarded;
an SDU corresponding to the data packet or the data packet group has been discarded;
the SDU corresponding to the data packet or the data packet group has not been discarded;
a delay of the data packet or data packet group exceeds a preset time;
the delay of the data packet or data packet group does not exceed the preset time;
a discard timer corresponding to the SDU corresponding to the data packet or the data packet group has expired;
the discard timer corresponding to the SDU corresponding to the data packet or the data packet group has not expired;
a remaining delay corresponding to the data packet or the data packet group is less than a preset threshold; and
the remaining delay corresponding to the data packet or the data packet group is greater than or equal to the preset threshold.

Optionally, the status of the SDU includes at least one of the following:
the SDU has been correctly transmitted;
the SDU has not been correctly transmitted;
a data packet or data packet group corresponding to the SDU has not been correctly transmitted;
the data packet or data packet group corresponding to the SDU has been delivered to the lower layer or the upper layer;
the data packet or data packet group corresponding to the SDU has not been delivered to the lower layer or the upper layer;
the SDU has been delivered to the lower layer or the upper layer;
the SDU has not been delivered to the lower layer or the upper layer; the SDU has been discarded;
the SDU has not been discarded;
the data packet or data packet group corresponding to the SDU has been discarded; the data packet or data packet group corresponding to the SDU has not been discarded;
a delay of the SDU exceeds a preset time;
the delay of the SDU does not exceed the preset time;
a discard timer corresponding to the data packet or the data packet group corresponding to the SDU has expired;
the discard timer corresponding to the data packet or the data packet group corresponding to the SDU has not expired;
a remaining delay corresponding to the SDU is less than a preset threshold; and the remaining delay corresponding to the SDU is greater than or equal to the preset threshold.

Optionally, the first data packet includes at least one of the following: a data packet in the first protocol layer entity, a problematic data packet, a data packet corresponding to a problematic SDU, a data packet corresponding to an SDU in the first protocol layer entity, and a data packet corresponding to the first SDU;
and/or
the first data packet group includes at least one of the following: a data packet group in the first protocol layer entity, a problematic data packet group, a data packet group corresponding to a problematic SDU, a data packet group corresponding to an SDU in the first protocol layer entity, and a data packet group corresponding to the first SDU;
and/or
the first SDU includes at least one of the following: a problematic SDU, an SDU in the first protocol layer entity, an SDU corresponding to a problematic data packet, an SDU corresponding to a problematic data packet group, an SDU corresponding to a data packet in the first protocol layer entity, and an SDU corresponding to a data packet group in the first protocol layer entity.

Optionally, the problematic data packet or data packet group includes at least one of the following:
a data packet or data packet group that has not been correctly transmitted;
a data packet or data packet group expected not to be correctly transmitted;
a data packet or data packet group corresponding to an SDU that has not been correctly transmitted;
a data packet or data packet group corresponding to an SDU expected not to be correctly transmitted;
a data packet or data packet group that has not been delivered to the lower layer or upper layer;
a data packet or data packet group expected not to be delivered to the lower layer or upper layer;
a data packet or data packet group corresponding to an SDU that has not been delivered to the lower layer or upper layer;
a data packet or data packet group corresponding to an SDU expected not to be delivered to the lower layer or upper layer;
a data packet or data packet group that has been discarded;
a data packet or data packet group expected to be discarded;
a data packet or data packet group corresponding to an SDU that has been discarded;
a data packet or data packet group corresponding to an SDU expected to be discarded;
a data packet or data packet group with a delay exceeding a preset time;
a data packet or data packet group expected to have a delay exceeding a preset time;
a data packet or data packet group corresponding to an SDU with a delay exceeding a preset time;
a data packet or data packet group corresponding to an SDU expected to have a delay exceeding a preset time;
a data packet or data packet group with a corresponding discard timer that has expired;
a data packet or data packet group expected to have a corresponding discard timer expire;
a data packet or data packet group corresponding to an SDU with a corresponding discard timer that has expired;
a data packet or data packet group corresponding to an SDU expected to have a corresponding discard timer expire;
a data packet or data packet group corresponding to an SDU with a remaining delay less than a preset threshold; and
a data packet or data packet group corresponding to an SDU expected to have a remaining delay less than the preset threshold.

Optionally, the problematic SDU includes at least one of the following:
an SDU that has not been correctly transmitted;
an SDU expected not to be correctly transmitted;
an SDU corresponding to a data packet or data packet group that has not been correctly transmitted;
an SDU corresponding to a data packet or data packet group expected not to be correctly transmitted;
an SDU that has not been delivered to the lower layer or upper layer;
an SDU expected not to be delivered to the lower layer or upper layer;
an SDU corresponding to a data packet or data packet group that has not been delivered to the lower layer or upper layer;
an SDU corresponding to a data packet or data packet group expected not to be delivered to the lower layer or upper layer;
an SDU that has been discarded;
an SDU expected to be discarded;
an SDU corresponding to a data packet or data packet group that has been discarded;
an SDU corresponding to a data packet or data packet group expected to be discarded;
an SDU with a delay exceeding a preset time;
an SDU expected to have a delay exceeding a preset time;
an SDU corresponding to a data packet or data packet group with a delay exceeding a preset time;
an SDU corresponding to a data packet or data packet group expected to have a delay exceeding a preset time;
an SDU with a corresponding discard timer that has expired;
an SDU expected to have a corresponding discard timer expire;
an SDU corresponding to a data packet or data packet group with a corresponding discard timer that has expired;
an SDU corresponding to a data packet or data packet group expected to have a corresponding discard timer expire;
an SDU corresponding to a data packet or data packet group with a remaining delay less than a preset threshold;
an SDU corresponding to a data packet or data packet group expected to have a remaining delay less than the preset threshold;
an SDU expected to have a remaining delay less than the preset threshold; and an SDU expected to have a remaining delay less than the preset threshold.

Optionally, the first response message includes at least one of the following:
first acknowledgment information, where the first acknowledgment information is used to indicate whether the second protocol layer entity has received the first information, or the first acknowledgment information is used to indicate whether the second protocol layer entity has not received the first information;
an identifier related to a third data object, where the third data object includes at least part of data objects in the first data object;
an identifier related to a fourth data object, where the fourth data object includes at least part of data objects associated with the first data object;
a status related to the fourth data object;
an identifier related to a fifth data object, where the fifth data object includes at least part of data objects in the second data object; and
a status related to the fifth data object.

Optionally, the related information of the data object of the second protocol layer entity includes at least one of the following:
related information of a sixth data object, where the sixth data object is a data object of the second protocol layer entity, and the sixth data object includes at least one of a third data packet and a third data packet group; and
related information of a seventh data object, where the seventh data object is a data object associated with the sixth data object.

Optionally, the related information of the sixth data object includes at least one of the following: an identifier related to the sixth data object and a status related to the sixth data object;
and/or
the related information of the seventh data object includes an identifier related to the seventh data object.

Optionally, the sixth data object includes at least one of the following:
a data object currently being processed;
a data object corresponding to an SDU currently being processed;
a data object that has not been correctly transmitted;
a data object corresponding to an SDU that has not been correctly transmitted;
a data object that has not been delivered to the lower layer or upper layer;
a data object corresponding to an SDU that has not been delivered to the lower layer or upper layer;
a data object that has been discarded;
a data object corresponding to an SDU that has been discarded;
a data object with a delay exceeding a preset time;
a data object corresponding to an SDU with a delay exceeding a preset time;
a data object with a discard timer that has expired;
a data object corresponding to an SDU with a discard timer that has expired;
a data object with a remaining delay less than a preset threshold; and
a data object corresponding to an SDU with a remaining delay less than preset threshold.

Optionally, the seventh data object includes at least one of the following:
a data packet associated with the third data packet;
a data packet group associated with the third data packet;
a data packet associated with a data packet group to which the third data packet belongs;
a data packet group associated with a data packet group to which the third data packet belongs;
a data packet associated with the third data packet group; and
a data packet group associated with the third data packet group.

Optionally, the second protocol layer entity sending the second information to the first protocol layer entity includes:
in a case that a third condition is met, sending, by the second protocol layer entity, the second information to the first protocol layer entity; where
the third condition includes at least one of the following:
fifth indication information sent by the network-side device has been received, where the fifth indication information is used to indicate the second protocol layer entity to send the second information to the first protocol layer entity;
the first information sent by the first protocol layer entity has been received;
a third request message sent by a third target protocol layer entity has been received, where the third request message is used for requesting the second protocol layer entity to send the second information to the first protocol layer entity;
a data packet or data packet group has arrived at the second protocol layer entity;
an upper layer data packet has arrived at the second protocol layer entity;
the second protocol layer entity is processing a data packet or a data packet group;
the second protocol layer entity has delivered a data packet or a data packet group or a PDCP protocol data unit PDU or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded;
an SDU corresponding to the data packet or the data packet group has been discarded;
the SDU corresponding to the data packet or the data packet group has not been discarded;
the data packet or data packet group corresponding to the SDU has been discarded;
the data packet or data packet group corresponding to the SDU has not been discarded;
a delay of the data packet, the data packet group, or the SDU exceeds a preset time;
a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; and
the remaining delay corresponding to the data packet, the data packet group, or the SDU is greater than or equal to the preset threshold.

Optionally, after the second protocol layer entity performs the second operation, the method further includes:
receiving, by the second protocol layer entity, third information from the first protocol layer entity, where the third information is a response message to the second information.

Optionally, the third information includes at least one of the following:
second acknowledgment information, where the second acknowledgment information is used to indicate whether the first protocol layer entity has received the second information, or the second acknowledgment information is used to indicate whether the first protocol layer entity has not received the second information;
an identifier related to an eighth data object, where the eighth data object includes at least one of the following: at least part of data objects in the third data object, at least part of data objects in the fourth data object, at least part of data objects in the fifth data object, at least part of data objects in the sixth data object, and at least part of data objects in the seventh data object;
an identifier related to a ninth data object, where the ninth data object is a data object related to the eighth data object; and
an identifier related to a tenth data object, where the tenth data object is a data object on which target processing is performed based on the second information.

It should be noted that for the implementation of this embodiment, reference may be made to the related description of the embodiment shown in FIG. 5, and details are not repeated here.

To sum up, in this embodiment of this application, coordination processing between data packets or data packet groups mapped to different DRBs can be implemented through coordination between different protocol layer entities (that is, PDCP entities) of the communication device. For example, in a case that the second protocol layer entity can obtain the status related to the first data object of the first protocol layer entity, the data object associated with the first data object in the second protocol layer entity can be processed based on the status related to the first data object. For example, for a data object having been discarded or a data object having not been correctly transmitted in the first protocol layer entity, the second protocol layer entity can correspondingly discard its associated data object. For a data objects having been delivered to the lower layer or the upper layer in the first protocol layer entity, the second protocol layer entity can correspondingly deliver its associated data object to the lower layer or the upper layer, which can effectively ensure maximization of resource utilization and efficiency of data packet transmission, thus improving the system capacity and reducing power consumption of the terminal.

It should be noted that the information transmission method in this embodiment of this application may be performed by an information transmission apparatus or a control module for performing the information transmission method in the information transmission apparatus. In the embodiments of this application, the information transmission apparatus provided in the embodiments of this application is described by using the information transmission method being executed by the information transmission apparatus as an example.

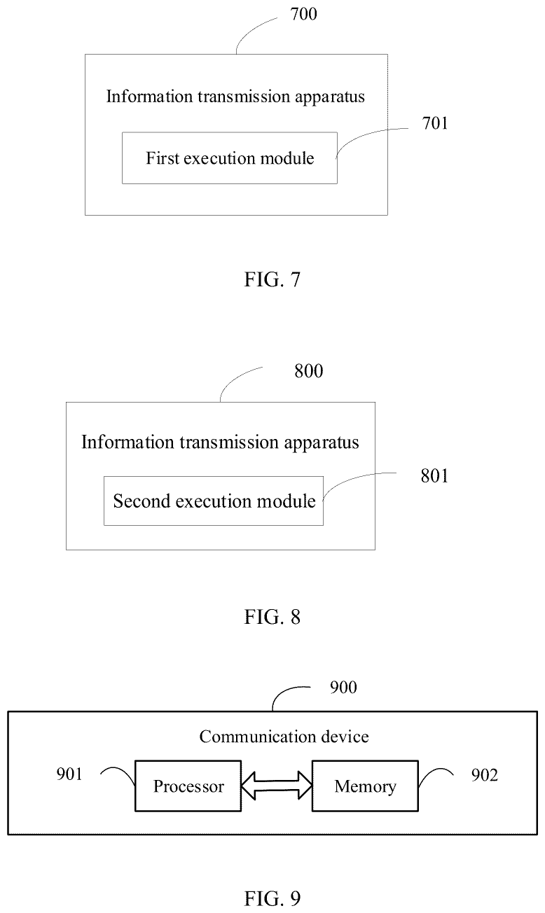

Referring to FIG. 7, FIG. 7 is a structural diagram of an information transmission apparatus according to an embodiment of this application. As shown in FIG. 7, the information transmission apparatus 700 includes:
a first execution module 701, configured to perform a first operation, where the first operation includes at least one of the following:
sending first information to a second protocol layer entity, where the first information is used for requesting information about a data object associated with a data object of the first protocol layer entity from the second protocol layer entity, and the data object includes at least one of a data packet, a data packet group, and a service data unit SDU; and
receiving second information from the second protocol layer entity, where the second information is a first response message to the first information, or the second information includes related information of a data object of the second protocol layer entity; where
the first protocol layer entity and the second protocol layer entity are located in a same communication device.

Optionally, the first information includes at least one of the following:
related information of a first data object, where the first data object is a data object of the first protocol layer entity, and the first data object includes at least one of a first data packet, a first data packet group, and a first SDU;
related information of a second data object, where the second data object is a data object associated with the first data object; and
first request information, where the first request information is used to request the second protocol layer entity to obtain a related status of the second data object.

Optionally, the second data object includes at least one of a second data packet and
a second data packet group.

The second data packet includes at least one of the following:
a data packet associated with the first data packet;
a data packet associated with a data packet group to which the first data packet belongs;
a data packet associated with the first data packet group;
a data packet associated with a data packet corresponding to the first SDU;
a data packet associated with a data packet group corresponding to the first SDU; and
a data packet associated with a data packet group to which a data packet corresponding to the first SDU belongs;
and/or
the second data packet group includes at least one of the following:
a data packet group associated with the first data packet;
a data packet group associated with the data packet group to which the first data packet belongs;
a data packet group associated with the first data packet group;
a data packet group associated with a data packet corresponding to the first SDU;
a data packet group associated with a data packet group corresponding to the first SDU; and
a data packet group associated with a data packet group to which a data packet corresponding to the first SDU belongs.

Optionally, the related information of the first data object includes at least one of the following: an identifier related to the first data object and a status related to the first data object;
and/or
the related information of the second data object includes an identifier related to the second data object.

Optionally, the identifier related to the first data object includes at least one of the following:
an identifier of the first data packet;
a sequence number SN of the first data packet;
a quality of service QoS flow identifier corresponding to the first data packet;
an identifier of a protocol layer corresponding to the first data packet;
an identifier of the first data packet group;
an SN of the first data packet group;
a QoS flow identifier corresponding to the first data packet group;
an identifier of a protocol layer corresponding to the first data packet group;
an identifier of a data packet corresponding to the first SDU;
an SN of a data packet corresponding to the first SDU;
a QoS flow identifier corresponding to a data packet corresponding to the first SDU; an identifier of a protocol layer corresponding to a data packet corresponding to the first SDU;
an identifier of a data packet group corresponding to the first SDU;
an SN of a data packet group corresponding to the first SDU;
a QoS flow identifier corresponding to a data packet group corresponding to the first SDU; and
an identifier of a protocol layer corresponding to a data packet group corresponding to the first SDU.

Optionally, the identifier of the protocol layer includes at least one of the following:
a packet data convergence protocol PDCP SN;
a data radio bearer DRB identifier;
a radio link control RLC bearer identifier; and
a media access control MAC logical channel identifier.

Optionally, the status related to the first data object includes at least one of the following:
a status of the first data packet;
a status of the first data packet group;
a status of an SDU corresponding to the first data packet;
a status of an SDU corresponding to the first data packet group;
a status of the first SDU;
a status of a data packet corresponding to the first SDU; and
a status of a data packet group corresponding to the first SDU.

Optionally, the identifier related to the second data object includes at least one of the following:
an identifier of the second data object;
an SN of the second data object;
a QoS flow identifier corresponding to the second data object; and an identifier of a protocol layer corresponding to the second data object.

Optionally, the status of the data packet or the data packet group includes at least one of the following:
the data packet or data packet group has been correctly transmitted;
the data packet or data packet group has not been correctly transmitted;
an SDU corresponding to the data packet or the data packet group has not been correctly transmitted;
the data packet or data packet group has been delivered to a lower layer or an upper layer;
the data packet or data packet group has not been delivered to the lower layer or the upper layer;
the SDU corresponding to the data packet or the data packet group has not been delivered to the lower layer or the upper layer;
the data packet or data packet group has been discarded;
the data packet or data packet group has not been discarded;
an SDU corresponding to the data packet or the data packet group has been the SDU corresponding to the data packet or the data packet group has not been discarded;
a delay of the data packet or a delay of the data packet group exceeds a preset time;
the delay of the data packet or the delay of the data packet group does not exceed the preset time;
a discard timer corresponding to the SDU corresponding to the data packet or the data packet group has expired;
the discard timer corresponding to the SDU corresponding to the data packet or the data packet group has not expired;
a remaining delay corresponding to the data packet or the data packet group is less than a preset threshold; and
the remaining delay corresponding to the data packet or the data packet group is greater than or equal to the preset threshold.

Optionally, the status of the SDU includes at least one of the following:
the SDU has been correctly transmitted;
the SDU has not been correctly transmitted;
a data packet or data packet group corresponding to the SDU has not been correctly transmitted;
the data packet or data packet group corresponding to the SDU has been delivered to the lower layer or the upper layer;
the data packet or data packet group corresponding to the SDU has not been delivered to the lower layer or the upper layer;
the SDU has been delivered to the lower layer or the upper layer;
the SDU has not been delivered to the lower layer or the upper layer;
the SDU has been discarded;
the SDU has not been discarded;
the data packet or data packet group corresponding to the SDU has been discarded;
the data packet or data packet group corresponding to the SDU has not been
a delay of the SDU exceeds a preset time;
the delay of the SDU does not exceed the preset time;
a discard timer corresponding to the data packet or the data packet group corresponding to the SDU has expired;
the discard timer corresponding to the data packet or the data packet group corresponding to the SDU has not expired;
a remaining delay corresponding to the SDU is less than a preset threshold; and the remaining delay corresponding to the SDU is greater than or equal to the preset threshold.

Optionally, the first data packet includes at least one of the following: a data packet in the first protocol layer entity, a problematic data packet, a data packet corresponding to a problematic SDU, a data packet corresponding to an SDU in the first protocol layer entity, and a data packet corresponding to the first SDU;
and/or
the first data packet group includes at least one of the following: a data packet group in the first protocol layer entity, a problematic data packet group, a data packet group corresponding to a problematic SDU, a data packet group corresponding to an SDU in the first protocol layer entity, and a data packet group corresponding to the first SDU;
and/or
the first SDU includes at least one of the following: a problematic SDU, an SDU in the first protocol layer entity, an SDU corresponding to a problematic data packet, an SDU corresponding to a problematic data packet group, an SDU corresponding to a data packet in the first protocol layer entity, and an SDU corresponding to a data packet group in the first protocol layer entity.

Optionally, the problematic data packet or data packet group includes at least one of the following:
a data packet or data packet group that has not been correctly transmitted;
a data packet or data packet group expected not to be correctly transmitted;
a data packet or data packet group corresponding to an SDU that has not been correctly transmitted;
a data packet or data packet group corresponding to an SDU expected not to be correctly transmitted;
a data packet or data packet group that has not been delivered to the lower layer or upper layer;
a data packet or data packet group expected not to be delivered to the lower layer or upper layer;
a data packet or data packet group corresponding to an SDU that has not been delivered to the lower layer or upper layer;
a data packet or data packet group corresponding to an SDU expected not to be delivered to the lower layer or upper layer;
a data packet or data packet group that has been discarded;
a data packet or data packet group expected to be discarded;
a data packet or data packet group corresponding to an SDU that has been discarded;
a data packet or data packet group corresponding to an SDU expected to be discarded;
a data packet or data packet group with a delay exceeding a preset time;
a data packet or data packet group expected to have a delay exceeding a preset time;
a data packet or data packet group corresponding to an SDU with a delay exceeding a preset time;
a data packet or data packet group corresponding to an SDU expected to have a delay exceeding a preset time;
a data packet or data packet group with a corresponding discard timer that has expired;
a data packet or data packet group expected to have a corresponding discard timer expire;
a data packet or data packet group corresponding to an SDU with a corresponding discard timer that has expired;
a data packet or data packet group corresponding to an SDU expected to have a corresponding discard timer expire;
a data packet or data packet group corresponding to an SDU with a remaining delay less than a preset threshold; and
a data packet or data packet group corresponding to an SDU expected to have a remaining delay less than the preset threshold.

Optionally, the problematic SDU includes at least one of the following:
an SDU that has not been correctly transmitted;
an SDU expected not to be correctly transmitted;
an SDU corresponding to a data packet or data packet group that has not been correctly transmitted;
an SDU corresponding to a data packet or data packet group expected not to be correctly transmitted;
an SDU that has not been delivered to the lower layer or upper layer;
an SDU expected not to be delivered to the lower layer or upper layer;
an SDU corresponding to a data packet or data packet group that has not been delivered to the lower layer or upper layer;
an SDU corresponding to a data packet or data packet group expected not to be delivered to the lower layer or upper layer;
an SDU that has been discarded;
an SDU expected to be discarded;
an SDU corresponding to a data packet or data packet group that has been discarded;
an SDU corresponding to a data packet or data packet group expected to be discarded;
an SDU with a delay exceeding a preset time;
an SDU expected to have a delay exceeding a preset time;
an SDU corresponding to a data packet or data packet group with a delay exceeding a preset time;
an SDU corresponding to a data packet or data packet group expected to have a delay exceeding a preset time;
an SDU with a corresponding discard timer that has expired;
an SDU expected to have a corresponding discard timer expire;
an SDU corresponding to a data packet or data packet group with a corresponding discard timer that has expired;
an SDU corresponding to a data packet or data packet group expected to have a corresponding discard timer expire;
an SDU corresponding to a data packet or data packet group with a remaining delay less than a preset threshold;
an SDU corresponding to a data packet or data packet group expected to have a remaining delay less than the preset threshold;
an SDU expected to have a remaining delay less than the preset threshold; and
an SDU expected to have a remaining delay less than the preset threshold.

Optionally, the remaining delay of the data packet or data packet group includes at least one of the following:
a remaining packet delay budget PDB or a remaining protocol data unit set delay budget PSDB of the data packet or data packet group;
a remaining PDB or a remaining PSDB of the data packet or data packet group in the communication device or at the first protocol layer; and
a remaining delay requirement of the data packet or data packet group in the communication device or at the second protocol layer.

Optionally, the preset time includes at least one of the following: a PDB or a remaining PDB, and a PSDB or a remaining PSDB.

Optionally, the PDB or the PSDB is a delay requirement of a data object of the communication device;
or,
the PDB or the PSDB is a delay requirement of a data object of the communication device in a preset node, and the communication device is a terminal.

Optionally, the first response message includes at least one of the following:
first acknowledgment information, where the first acknowledgment information is used to indicate whether the second protocol layer entity has received the first information, or the first acknowledgment information is used to indicate whether the second protocol layer entity has not received the first information;
an identifier related to a third data object, where the third data object includes at least part of data objects in the first data object;
an identifier related to a fourth data object, where the fourth data object includes at least part of data objects associated with the first data object;
a status related to the fourth data object;
an identifier related to a fifth data object, where the fifth data object includes at least part of data objects in the second data object; and
a status related to the fifth data object.

Optionally, the related information of the data object of the second protocol layer entity includes at least one of the following:
related information of a sixth data object, where the sixth data object is a data object of the second protocol layer entity, and the sixth data object includes at least one of a third data packet and a third data packet group; and
related information of a seventh data object, where the seventh data object is a data object associated with the sixth data object.

Optionally, the related information of the sixth data object includes at least one of the following: an identifier related to the sixth data object and a status related to the sixth data object;
and/or
the related information of the seventh data object includes an identifier related to the seventh data object.

Optionally, the identifier related to the sixth data object includes at least one of the following:
an identifier of the third data packet;
an SN of the third data packet;
an identifier of a data packet group to which the third data packet belongs;
an SN of the data packet group to which the third data packet belongs;
a QoS flow identifier corresponding to the third data packet;
an identifier of a protocol layer corresponding to the third data packet;
an identifier of the third data packet group;
an SN of the third data packet group;
a QoS flow identifier corresponding to the third data packet group; and
an identifier of a protocol layer corresponding to the third data packet group.

Optionally, the status related to the sixth data object includes at least one of the following:
the sixth data object has been correctly transmitted;
the sixth data object has not been correctly transmitted;
an SDU corresponding to the sixth data object has not been correctly transmitted;
a remaining data packet or data packet group of the sixth data object;
the sixth data object has been delivered to the lower layer or the upper layer;
the sixth data object has not been delivered to the lower layer or the upper layer;
the SDU corresponding to the sixth data object has not been delivered to the lower layer or the upper layer;
the sixth data object has been discarded;
the sixth data object has not been discarded;
the SDU corresponding to the sixth data object has been discarded;
the SDU corresponding to the sixth data object has not been discarded;
a delay of the sixth data object exceeds a preset time;
the delay of the sixth data object does not exceed the preset time;
a discard timer corresponding to the SDU corresponding to the sixth data object has expired;
the discard timer corresponding to the SDU corresponding to the sixth data object has not expired; and
a remaining delay corresponding to the sixth data object is less than a preset threshold.

Optionally, the seventh data object includes at least one of a fourth data packet and a fourth data packet group, and the identifier related to the seventh data object includes at least one of the following:
an identifier of the fourth data packet;
an SN of the fourth data packet;
an identifier of a data packet group to which the fourth data packet belongs;
an SN of the data packet group to which the fourth data packet belongs;
a QoS flow identifier corresponding to the fourth data packet;
an identifier of a protocol layer corresponding to the fourth data packet;
an identifier of the fourth data packet group;
an SN of the fourth data packet group;
a QoS flow identifier corresponding to the fourth data packet group; and
an identifier of a protocol layer corresponding to the fourth data packet group.

Optionally, the sixth data object includes at least one of the following:
a data object currently being processed;
a data object corresponding to an SDU currently being processed;
a data object that has not been correctly transmitted;
a data object corresponding to an SDU that has not been correctly transmitted;
a data object that has not been delivered to the lower layer or upper layer;
a data object corresponding to an SDU that has not been delivered to the lower layer or upper layer;
a data object that has been discarded;
a data object corresponding to an SDU that has been discarded;
a data object with a delay exceeding a preset time;
a data object corresponding to an SDU with a delay exceeding a preset time;
a data object with a discard timer that has expired;
a data object corresponding to an SDU with a discard timer that has expired;
a data object with a remaining delay less than a preset threshold; and
a data object corresponding to an SDU with a remaining delay less than preset threshold.

Optionally, the seventh data object includes at least one of the following:
a data packet associated with the third data packet;
a data packet group associated with the third data packet;
a data packet associated with a data packet group to which the third data packet belongs;
a data packet group associated with a data packet group to which the third data packet belongs;
a data packet associated with the third data packet group; and
a data packet group associated with the third data packet group.

Optionally, the first execution module is specifically configured to:
in a case that a first condition is met, send the first information to the second protocol layer entity; where
the first condition includes at least one of the following:
first indication information sent by a network-side device has been received, where the first indication information is used to indicate the first protocol layer entity to send the first information to the second protocol layer entity;
second indication information sent by an upper layer of the first protocol layer entity has been received, where the second indication information is used to indicate the first protocol layer entity to send the first information to the second protocol layer entity;
a first request message sent by a first target protocol layer entity has been received, where the first request message is used for requesting the first protocol layer entity to send the first information to the second protocol layer entity;
a data packet or data packet group has arrived at the first protocol layer entity;
an upper layer data packet has arrived at the first protocol layer entity;
the first protocol layer entity has delivered a data packet or a data packet group or a PDCP protocol data unit PDU or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded; an SDU corresponding to the data packet or the data packet group has been discarded;
the SDU corresponding to the data packet or the data packet group has not been discarded;
the data packet or data packet group corresponding to the SDU has been discarded; the data packet or data packet group corresponding to the SDU has not been discarded;
a delay of the data packet, the data packet group, or the SDU exceeds a preset time;
a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; and
the remaining delay corresponding to the data packet, the data packet group, or the SDU is greater than or equal to the preset threshold.

Optionally, the apparatus further includes:
a first sending module, configured to send third information to the second protocol layer entity after the first operation is performed, where the third information is a response message to the second information.

Optionally, the third information includes at least one of the following:
second acknowledgment information, where the second acknowledgment information is used to indicate whether the first protocol layer entity has received the second information, or the second acknowledgment information is used to indicate whether the first protocol layer entity has not received the second information;
an identifier related to an eighth data object, where the eighth data object includes at least one of the following: at least part of data objects in the third data object, at least part of data objects in the fourth data object, at least part of data objects in the fifth data object, at least part of data objects in the sixth data object, and at least part of data objects in the seventh data object;
an identifier related to a ninth data object, where the ninth data object is a data object related to the eighth data object; and
an identifier related to a tenth data object, where the tenth data object is a data object on which target processing is performed based on the second information.

Optionally, the target processing includes at least one of the following: discarding, not discarding, transmitting, not transmitting, delivering to the upper layer or lower layer, and not delivering to the upper layer or lower layer.

Optionally, the first sending module is specifically configured to:
in a case that a second condition is met, send the third information to the second protocol layer entity; where
the second condition includes at least one of the following:
third indication information sent by the network-side device has been received, where the third indication information is used to indicate the first protocol layer entity to send the third information to the second protocol layer entity;
fourth indication information sent by the upper layer has been received, where the fourth indication information is used to indicate the first protocol layer entity to send the third information to the second protocol layer entity;
a second request message sent by a second target protocol layer entity has been received, where the second request message is used for requesting the first protocol layer entity to send the third information to the second protocol layer entity;
a data packet or data packet group has arrived at the first protocol layer entity;
an upper layer data packet has arrived at the first protocol layer entity;
the first protocol layer entity is processing a data packet or a data packet group;
the first protocol layer entity has delivered a data packet or a data packet group or a PDCP PDU or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded;
an SDU corresponding to the data packet or the data packet group has been discarded;
the SDU corresponding to the data packet or the data packet group has not been discarded;
the data packet or data packet group corresponding to the SDU has been discarded; the data packet or data packet group corresponding to the SDU has not been discarded;
a delay of the data packet, the data packet group, or the SDU exceeds a preset time; a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; and
the remaining delay corresponding to the data packet, the data packet group, or the SDU is greater than or equal to the preset threshold.

Optionally, the apparatus further includes:
a first receiving module, configured to receive fourth information from the upper layer or the lower layer before the first operation is performed, where the fourth information is used to request the first protocol layer entity to send the first information to the second protocol layer entity.

Optionally, the fourth information includes at least one of the following:
related information of the first data object;
related information of the second data object; and
second request information, where the second request information is used for requesting the first protocol layer entity to obtain a status related to the second data object from the second protocol layer entity.

Optionally, the apparatus further includes:
a second sending module, configured to send the fifth information to the upper layer or the lower layer after the first operation is performed; where
the fifth information includes at least one of the following:
third acknowledgment information, where the third acknowledgment information is used to indicate whether the first protocol layer entity has received the fourth information, or the third acknowledgment information is used to indicate whether the first protocol layer entity has not received the fourth information;
an identifier related to an eleventh data object, where the eleventh data object includes at least one of the following: at least part of data objects in the third data object, at least part of data objects in the fourth data object, at least part of data objects in the fifth data object, at least part of data objects in the sixth data object, and at least part of data objects in the seventh data object;
an identifier related to a twelfth data object, where the twelfth data object is a data object related to the eleventh data object; and an identifier related to a thirteenth data object, where the thirteenth data object is a data object on which target processing is performed in response to the second information.

Optionally, the data object associated with the data object of the first protocol layer entity includes at least one of the following:
a data object belonging to a same group as the data object of the first protocol layer entity;
a data object belonging to a same data packet as the data object of the first protocol layer entity;
a data object having a dependency relationship with the data object of the first protocol layer entity; and
a data object having a correlation with the data object of the first protocol layer entity.

Optionally, the data packet includes at least one of the following: a packet data convergence protocol PDCP SDU, a PDCP PDU, data in a PDCP buffer, a corresponding data packet carried by RLC, a data packet corresponding to a MAC SDU, a data packet corresponding to a MAC PDU, a PDU, a PDU set, a burst, a frame, a slice, a picture, a group of picture (GOP), a PDU set group, a PDU group, and an IP packet.

Optionally, the data packet group includes at least one of the following: a PDU set group, a PDU set, a burst, a frame, a slice, a picture, a GOP, a PDU set group, a PDU group, an IP packet, at least two data packets, an upper layer data packet, and a data packet corresponding to a QoS flow.

The information transmission apparatus in this embodiment of this application may be an electronic device, such as an electronic device with an operating system, or a component in the electronic device, such as an integrated circuit or a chip. The electronic device may be a terminal or a network-side device, or may be other devices than the terminal or the network-side device. For example, the terminal may include but is not limited to the types of the terminal 11 listed above, the network-side device may include but is not limited to the types of the network-side device 12 listed above, and other devices may be servers, network attached storage (NAS), and so on, which are not specifically limited in the embodiments of this application.

The information transmission apparatus provided in this embodiment of this application can implement the processes implemented in the method embodiments in FIG. 5, with the same technical effects achieved. To avoid repetition, details are not described herein again.

Refer to FIG. 8. FIG. 8 is a structural diagram of an information transmission apparatus according to an embodiment of this application. As shown in FIG. 8, the information transmission apparatus 800 includes:
a second execution module 801, configured to perform a second operation, where the second operation includes at least one of the following:
receiving first information from a first protocol layer entity, where the first information is used for requesting information about a data object associated with a data object of the first protocol layer entity from the second protocol layer entity, and the data object includes at least one of a data packet, a data packet group, and a service data unit SDU; and
sending second information to the first protocol layer entity, where the second information is a first response message to the first information, or the second information includes related information of a data object of the second protocol layer entity; where
the first protocol layer entity and the second protocol layer entity are located in a same communication device.

Optionally, the first information includes at least one of the following:
related information of a first data object, where the first data object is a data object of the first protocol layer entity, and the first data object includes at least one of a first data packet, a first data packet group, and a first SDU;
related information of a second data object, where the second data object is a data object associated with the first data object; and
first request information, where the first request information is used to request the second protocol layer entity to obtain a related status of the second data object.

Optionally, the second data object includes at least one of a second data packet and a second data packet group.

The second data packet includes at least one of the following:
a data packet associated with the first data packet;
a data packet associated with a data packet group to which the first data packet belongs;
a data packet associated with the first data packet group;
a data packet associated with a data packet corresponding to the first SDU;
a data packet associated with a data packet group corresponding to the first SDU; and
a data packet associated with a data packet group to which a data packet corresponding to the first SDU belongs;
and/or
the second data packet group includes at least one of the following:
a data packet group associated with the first data packet;
a data packet group associated with the data packet group to which the first data packet belongs;
a data packet group associated with the first data packet group;
a data packet group associated with a data packet corresponding to the first SDU;
a data packet group associated with a data packet group corresponding to the first SDU; and

The data packet group associated with the data packet group to which the data packet corresponding to the first SDU belongs.

Optionally, the related information of the first data object includes at least one of the following: an identifier related to the first data object and a status related to the first data object;
and/or
the related information of the second data object includes an identifier related to the second data object.

Optionally, the identifier related to the first data object includes at least one of the following:
an identifier of the first data packet;
a sequence number SN of the first data packet;
a quality of service QoS flow identifier corresponding to the first data packet;
an identifier of a protocol layer corresponding to the first data packet;
an identifier of the first data packet group;
an SN of the first data packet group;
a QoS flow identifier corresponding to the first data packet group;
an identifier of a protocol layer corresponding to the first data packet group;
an identifier of a data packet corresponding to the first SDU;
an SN of a data packet corresponding to the first SDU;
a QoS flow identifier corresponding to a data packet corresponding to the first SDU;
an identifier of a protocol layer corresponding to a data packet corresponding to the first SDU;
an identifier of a data packet group corresponding to the first SDU;
an SN of a data packet group corresponding to the first SDU;
a QoS flow identifier corresponding to a data packet group corresponding to the first SDU; and
an identifier of a protocol layer corresponding to a data packet group corresponding to the first SDU.

Optionally, the identifier of the protocol layer includes at least one of the following:
a packet data convergence protocol PDCP SN;
a data radio bearer DRB identifier;
a radio link control RLC bearer identifier; and
a media access control MAC logical channel identifier.

Optionally, the status related to the first data object includes at least one of the following:
a status of the first data packet;
a status of the first data packet group;
a status of an SDU corresponding to the first data packet;
a status of an SDU corresponding to the first data packet group;
a status of the first SDU;
a status of a data packet corresponding to the first SDU; and
a status of a data packet group corresponding to the first SDU.

Optionally, the identifier related to the second data object includes at least one of the following:
an identifier of the second data object;
an SN of the second data object;
a QoS flow identifier corresponding to the second data object; and
an identifier of a protocol layer corresponding to the second data object.

Optionally, the status of the data packet or the data packet group includes at least one of the following:
the data packet or data packet group has been correctly transmitted;
the data packet or data packet group has not been correctly transmitted; an SDU corresponding to the data packet or the data packet group has not been correctly transmitted;
the data packet or data packet group has been delivered to a lower layer or an upper layer;
the data packet or data packet group has not been delivered to the lower layer or the upper layer;
the SDU corresponding to the data packet or the data packet group has not been delivered to the lower layer or the upper layer;
the data packet or data packet group has been discarded;
the data packet or data packet group has not been discarded;
an SDU corresponding to the data packet or the data packet group has been discarded;
the SDU corresponding to the data packet or the data packet group has not been discarded;
a delay of the data packet or data packet group exceeds a preset time;
the delay of the data packet or data packet group does not exceed the preset time;
a discard timer corresponding to the SDU corresponding to the data packet or the data packet group has expired;
the discard timer corresponding to the SDU corresponding to the data packet or the data packet group has not expired;
a remaining delay corresponding to the data packet or the data packet group is less than a preset threshold; and
the remaining delay corresponding to the data packet or the data packet group is greater than or equal to the preset threshold.

Optionally, the status of the SDU includes at least one of the following:
the SDU has been correctly transmitted;
the SDU has not been correctly transmitted;
a data packet or data packet group corresponding to the SDU has not been correctly transmitted;
the data packet or data packet group corresponding to the SDU has been delivered to the lower layer or the upper layer;
the data packet or data packet group corresponding to the SDU has not been delivered to the lower layer or the upper layer;
the SDU has been delivered to the lower layer or the upper layer;
the SDU has not been delivered to the lower layer or the upper layer;
the SDU has been discarded;
the SDU has not been discarded;
the data packet or data packet group corresponding to the SDU has been discarded;
the data packet or data packet group corresponding to the SDU has not been discarded;
a delay of the SDU exceeds a preset time;
the delay of the SDU does not exceed the preset time;
a discard timer corresponding to the data packet or the data packet group corresponding to the SDU has expired;
the discard timer corresponding to the data packet or the data packet group corresponding to the SDU has not expired;
a remaining delay corresponding to the SDU is less than a preset threshold; and the remaining delay corresponding to the SDU is greater than or equal to the preset threshold.

Optionally, the first data packet includes at least one of the following: a data packet in the first protocol layer entity, a problematic data packet, a data packet corresponding to a problematic SDU, a data packet corresponding to an SDU in the first protocol layer entity, and a data packet corresponding to the first SDU;
and/or
the first data packet group includes at least one of the following: a data packet group in the first protocol layer entity, a problematic data packet group, a data packet group corresponding to a problematic SDU, a data packet group corresponding to an SDU in the first protocol layer entity, and a data packet group corresponding to the first SDU;
and/or
the first SDU includes at least one of the following: a problematic SDU, an SDU in the first protocol layer entity, an SDU corresponding to a problematic data packet, an SDU corresponding to a problematic data packet group, an SDU corresponding to a data packet in the first protocol layer entity, and an SDU corresponding to a data packet group in the first protocol layer entity.

Optionally, the problematic data packet or data packet group includes at least one of the following:
a data packet or data packet group that has not been correctly transmitted; a data packet or data packet group expected not to be correctly transmitted;
a data packet or data packet group corresponding to an SDU that has not been correctly transmitted;
a data packet or data packet group corresponding to an SDU expected not to be correctly transmitted;
a data packet or data packet group that has not been delivered to the lower layer or upper layer;
a data packet or data packet group expected not to be delivered to the lower layer or upper layer;
a data packet or data packet group corresponding to an SDU that has not been delivered to the lower layer or upper layer;
a data packet or data packet group corresponding to an SDU expected not to be delivered to the lower layer or upper layer;
a data packet or data packet group that has been discarded;
a data packet or data packet group expected to be discarded;
a data packet or data packet group corresponding to an SDU that has been discarded;
a data packet or data packet group corresponding to an SDU expected to be discarded;
a data packet or data packet group with a delay exceeding a preset time;
a data packet or data packet group expected to have a delay exceeding a preset time; a data packet or data packet group corresponding to an SDU with a delay exceeding a preset time;
a data packet or data packet group corresponding to an SDU expected to have a delay exceeding a preset time;
a data packet or data packet group with a corresponding discard timer that has expired;
a data packet or data packet group expected to have a corresponding discard timer expire;
a data packet or data packet group corresponding to an SDU with a corresponding discard timer that has expired;
a data packet or data packet group corresponding to an SDU expected to have a corresponding discard timer expire;
a data packet or data packet group corresponding to an SDU with a remaining delay less than a preset threshold; and
a data packet or data packet group corresponding to an SDU expected to have a remaining delay less than the preset threshold.

Optionally, the problematic SDU includes at least one of the following:
an SDU that has not been correctly transmitted;
an SDU expected not to be correctly transmitted;
an SDU corresponding to a data packet or data packet group that has not been correctly transmitted;
an SDU corresponding to a data packet or data packet group expected not to be correctly transmitted;
an SDU that has not been delivered to the lower layer or upper layer;
an SDU expected not to be delivered to the lower layer or upper layer;
an SDU corresponding to a data packet or data packet group that has not been delivered to the lower layer or upper layer;
an SDU corresponding to a data packet or data packet group expected not to be delivered to the lower layer or upper layer;
an SDU that has been discarded;
an SDU expected to be discarded;
an SDU corresponding to a data packet or data packet group that has been discarded; an SDU corresponding to a data packet or data packet group expected to be discarded;
an SDU with a delay exceeding a preset time;
an SDU expected to have a delay exceeding a preset time;
an SDU corresponding to a data packet or data packet group with a delay exceeding a preset time;
an SDU corresponding to a data packet or data packet group expected to have a delay exceeding a preset time;
an SDU with a corresponding discard timer that has expired; an SDU expected to have a corresponding discard timer expire;
an SDU corresponding to a data packet or data packet group with a corresponding discard timer that has expired;
an SDU corresponding to a data packet or data packet group expected to have a corresponding discard timer expire;
an SDU corresponding to a data packet or data packet group with a remaining delay less than a preset threshold;
an SDU corresponding to a data packet or data packet group expected to have a remaining delay less than the preset threshold;
an SDU expected to have a remaining delay less than the preset threshold; and an SDU expected to have a remaining delay less than the preset threshold.

Optionally, the first response message includes at least one of the following:
first acknowledgment information, where the first acknowledgment information is used to indicate whether the second protocol layer entity has received the first information, or the first acknowledgment information is used to indicate whether the second protocol layer entity has not received the first information;
an identifier related to a third data object, where the third data object includes at least part of data objects in the first data object;
an identifier related to a fourth data object, where the fourth data object includes at least part of data objects associated with the first data object;
a status related to the fourth data object;
an identifier related to a fifth data object, where the fifth data object includes at least part of data objects in the second data object; and
a status related to the fifth data object.

Optionally, the related information of the data object of the second protocol layer entity includes at least one of the following:
related information of a sixth data object, where the sixth data object is a data object of the second protocol layer entity, and the sixth data object includes at least one of a third data packet and a third data packet group; and
related information of a seventh data object, where the seventh data object is a data object associated with the sixth data object.

Optionally, the related information of the sixth data object includes at least one of the following: an identifier related to the sixth data object and a status related to the sixth data object;
and/or
the related information of the seventh data object includes an identifier related to the seventh data object.

Optionally, the sixth data object includes at least one of the following:
a data object currently being processed;
a data object corresponding to an SDU currently being processed;
a data object that has not been correctly transmitted;
a data object corresponding to an SDU that has not been correctly transmitted;
a data object that has not been delivered to the lower layer or upper layer;
a data object corresponding to an SDU that has not been delivered to the lower layer or upper layer;
a data object that has been discarded;
a data object corresponding to an SDU that has been discarded;
a data object with a delay exceeding a preset time;
a data object corresponding to an SDU with a delay exceeding a preset time;
a data object with a discard timer that has expired;
a data object corresponding to an SDU with a discard timer that has expired;
a data object with a remaining delay less than a preset threshold; and
a data object corresponding to an SDU with a remaining delay less than preset threshold.

Optionally, the seventh data object includes at least one of the following:
a data packet associated with the third data packet;
a data packet group associated with the third data packet;
a data packet associated with a data packet group to which the third data packet belongs;
a data packet group associated with a data packet group to which the third data packet belongs;
a data packet associated with the third data packet group; and
a data packet group associated with the third data packet group.

Optionally, the second execution module is specifically configured to:
in a case that a third condition is met, send the second information to the first protocol layer entity; where
the third condition includes at least one of the following:
fifth indication information sent by the network-side device has been received, where the fifth indication information is used to indicate the second protocol layer entity to send the second information to the first protocol layer entity;
the first information sent by the first protocol layer entity has been received;
a third request message sent by a third target protocol layer entity has been received, where the third request message is used for requesting the second protocol layer entity to send the second information to the first protocol layer entity;
a data packet or data packet group has arrived at the second protocol layer entity;
an upper layer data packet has arrived at the second protocol layer entity;
the second protocol layer entity is processing a data packet or a data packet group;
the second protocol layer entity has delivered a data packet or a data packet group or a PDCP protocol data unit PDU or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded; an SDU corresponding to the data packet or the data packet group has been discarded;
the SDU corresponding to the data packet or the data packet group has not been discarded;
the data packet or data packet group corresponding to the SDU has been discarded; the data packet or data packet group corresponding to the SDU has not been discarded;
a delay of the data packet, the data packet group, or the SDU exceeds a preset time; a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; and
the remaining delay corresponding to the data packet, the data packet group, or the SDU is greater than or equal to the preset threshold.

Optionally, the apparatus further includes:
a first receiving module, configured to receive third information from the first protocol layer entity after the second operation is performed, where the third information is a response message to the second information.

Optionally, the third information includes at least one of the following:
second acknowledgment information, where the second acknowledgment information is used to indicate whether the first protocol layer entity has received the second information, or the second acknowledgment information is used to indicate whether the first protocol layer entity has not received the second information;
an identifier related to an eighth data object, where the eighth data object includes at least one of the following: at least part of data objects in the third data object, at least part of data objects in the fourth data object, at least part of data objects in the fifth data object, at least part of data objects in the sixth data object, and at least part of data objects in the seventh data object;
an identifier related to a ninth data object, where the ninth data object is a data object related to the eighth data object; and
an identifier related to a tenth data object, where the tenth data object is a data object on which target processing is performed based on the second information.

The information transmission apparatus in this embodiment of this application may be an electronic device, such as an electronic device with an operating system, or a component in the electronic device, such as an integrated circuit or a chip. The electronic device may be a terminal or a network-side device, or may be other devices than the terminal or the network-side device. For example, the terminal may include but is not limited to the types of the terminal 11 listed above, the network-side device may include but is not limited to the types of the network-side device 12 listed above, and other devices may be servers, network attached storage (NAS), and so on, which are not specifically limited in the embodiments of this application.

The information transmission apparatus provided in this embodiment of this application can implement the processes implemented in the method embodiments in FIG. 6, with the same technical effects achieved. To avoid repetition, details are not described herein again.

Optionally, as shown in FIG. 9, an embodiment of this application further provides a communication device 900, including a processor 901 and a memory 902, and the memory 902 stores a program or instructions capable of running on the processor 901. When the program or instructions are executed by the processor 901, the steps of the foregoing embodiments of the information transmission method may be implemented, with the same technical effects achieved. To avoid repetition, details are not described herein again.

An embodiment of this application further provides a terminal, which includes a processor and a communication interface, where the communication interface is configured to perform a first operation, where the first operation includes at least one of the following: sending first information to a second protocol layer entity, where the first information is used for requesting information about a data object associated with a data object of the first protocol layer entity from the second protocol layer entity, and the data object includes at least one of a data packet, a data packet group, and a service data unit SDU; and receiving second information from the second protocol layer entity, where the second information is a first response message to the first information, or the second information includes related information of a data object of the second protocol layer entity; where the first protocol layer entity and the second protocol layer entity are located in the terminal; or
the communication interface is configured to perform a second operation, where the second operation includes at least one of the following: receiving first information from the first protocol layer entity, where the first information is used for requesting information about a data object associated with a data object of the first protocol layer entity from the second protocol layer entity, and the data object includes at least one of a data packet, a data packet group, and a service data unit SDU; and sending second information to the first protocol layer entity, where the second information is a first response message to the first information, or the second information includes related information of a data object of the second protocol layer entity; where the first protocol layer entity and the second protocol layer entity are located in the terminal.

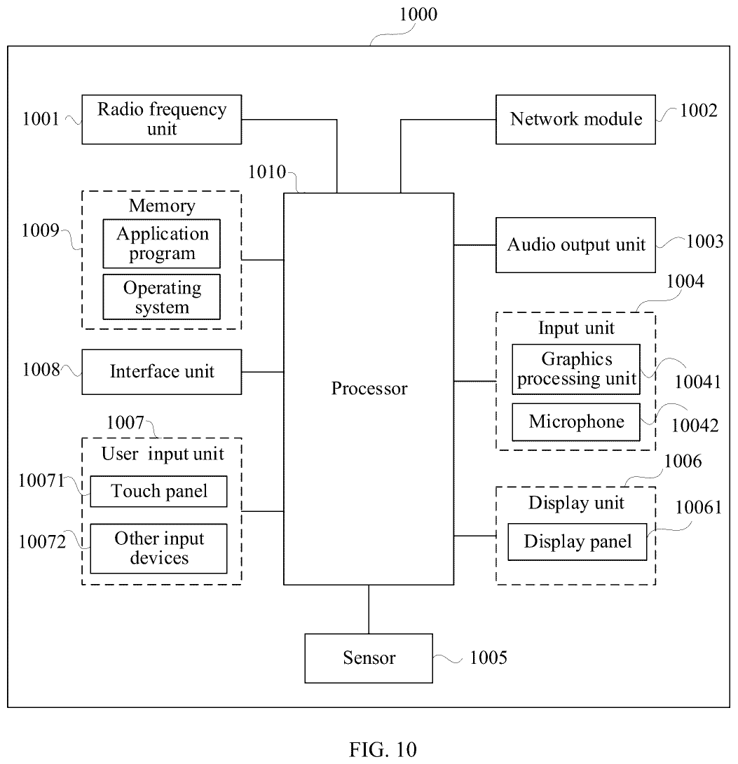

The terminal embodiment corresponds to the foregoing method embodiment, and the implementation processes and implementations of the foregoing method embodiments can be applied to the terminal embodiments, with the same technical effects achieved. Specifically, FIG. 10 is a schematic diagram of a hardware structure of a terminal implementing an embodiment of this application.

The terminal 1000 includes but is not limited to at least part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

Persons skilled in the art can understand that the terminal 1000 may further include a power supply (for example, a battery) supplying power to the components, and the power supply may be logically connected to the processor 1010 through a power management system. In this way, functions such as charge management, discharge management, and power consumption management are implemented by using the power management system. The structure of the terminal shown in FIG. 10 does not constitute any limitation on the terminal. The terminal may include more or fewer components than shown in the figure, or a combination of some components, or the components disposed differently. Details are not described herein again.

It can be understood that in this embodiment of this application, the input unit 1004 may include a graphics processing unit (GPU) 10041 and a microphone 10042. The graphics processing unit 10041 processes image data of a still picture or video obtained by an image capture apparatus (such as a camera) in a video capture mode or an image capture mode. The display unit 1006 may include the display panel 10061. The display panel 10061 may be configured in a form of a liquid crystal display, an organic light-emitting diode, or the like. The user input unit 1007 includes at least one of a touch panel 10071 and other input devices 10072. The touch panel 10071 is also referred to as a touchscreen. The touch panel 10071 may include two parts: a touch detection apparatus and a touch controller. The other input devices 10072 may include but are not limited to a physical keyboard, a function key (such as a volume control key or a power on/off key), a trackball, a mouse, a joystick, and the like. Details are not described herein.

In this embodiment of this application, after receiving downlink data from a network-side device, the radio frequency unit 1001 sends the downlink data to the processor 1010 for processing; and the radio frequency unit 1001 also sends uplink data to the network-side device. Generally, the radio frequency unit 1001 includes, but is not limited to, an antenna, an amplifier, a transceiver, a coupler, a low noise amplifier, a duplexer, and the like.

The memory 1009 may be configured to store software programs or instructions and various data. The memory 1009 may mainly include a first storage area for storing programs or instructions and a second storage area for storing data, where the first storage area may store an operating system, an application program or instructions required by at least one function (for example, an audio playing function and an image playing function), and the like. In addition, the memory 1009 may be a volatile memory or a non-volatile memory, or the memory 1009 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct memory bus random access memory (DRRAM). The memory 1009 described in this embodiment this application includes but is not limited to these and any other suitable types of memories.

The processor 1010 may include one or more processing units. Optionally, the processor 1010 integrates an application processor and a modem processor. The application processor mainly processes operations related to an operating system, a user interface, an application program, and the like. The modem processor mainly processes wireless communication signals, for example, a baseband processor. It can be understood that the modem processor may alternatively be not integrated in the processor 1010.

The radio frequency unit 1001 is configured to perform a first operation, where the first operation includes at least one of the following: sending first information to a second protocol layer entity, where the first information is used for requesting information about a data object associated with a data object of the first protocol layer entity from the second protocol layer entity, and the data object includes at least one of a data packet, a data packet group, and a service data unit SDU; and receiving second information from the second protocol layer entity, where the second information is a first response message to the first information, or the second information includes related information of a data object of the second protocol layer entity; where the first protocol layer entity and the second protocol layer entity are located in the terminal; or
the radio frequency unit 1001 is configured to perform a second operation, where the second operation includes at least one of the following: receiving first information from the first protocol layer entity, where the first information is used for requesting information about a data object associated with a data object of the first protocol layer entity from the second protocol layer entity, and the data object includes at least one of a data packet, a data packet group, and a service data unit SDU; and sending second information to the first protocol layer entity, where the second information is a first response message to the first information, or the second information includes related information of a data object of the second protocol layer entity; where the first protocol layer entity and the second protocol layer entity are located in the terminal.

An embodiment of this application further provides a network-side device, which includes a processor and a communication interface, where the communication interface is configured to perform a first operation, where the first operation includes at least one of the following: sending first information to a second protocol layer entity, where the first information is used for requesting information about a data object associated with a data object of the first protocol layer entity from the second protocol layer entity, and the data object includes at least one of a data packet, a data packet group, and a service data unit SDU; and receiving second information from the second protocol layer entity, where the second information is a first response message to the first information, or the second information includes related information of a data object of the second protocol layer entity; where the first protocol layer entity and the second protocol layer entity are located in the network-side device; or
the communication interface is configured to perform a second operation, where the second operation includes at least one of the following: receiving first information from the first protocol layer entity, where the first information is used for requesting information about a data object associated with a data object of the first protocol layer entity from the second protocol layer entity, and the data object includes at least one of a data packet, a data packet group, and a service data unit SDU; and sending second information to the first protocol layer entity, where the second information is a first response message to the first information, or the second information includes related information of a data object of the second protocol layer entity; where the first protocol layer entity and the second protocol layer entity are located in the network-side device.

The network-side device embodiment corresponds to the foregoing method embodiment, and the implementation processes and implementations of the foregoing method embodiments can be applied to the network-side device embodiment, with the same technical effects achieved.

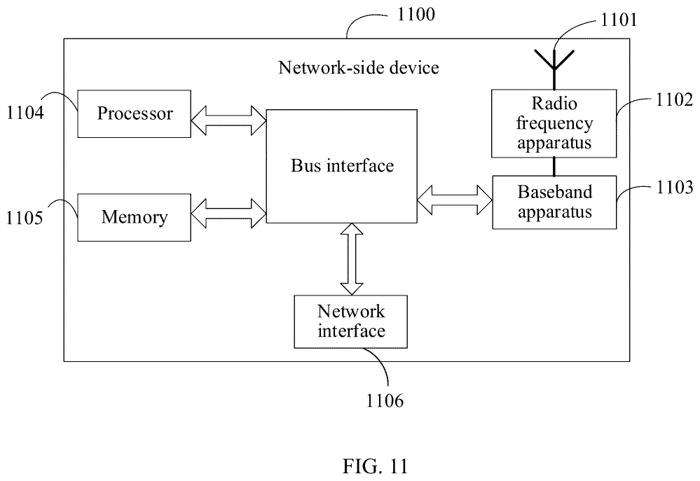

Specifically, an embodiment of this application further provides a network-side device. As shown in FIG. 11, the network-side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information by using the antenna 1101, and sends the received information to the baseband apparatus 1103 for processing. In a downlink direction, the baseband apparatus 1103 processes to-be-sent information, and sends the information to the radio frequency apparatus 1102; and the radio frequency apparatus 1102 processes the received information and then sends the information out by using the antenna 1101.

The method performed by the network-side device in the foregoing embodiment may be implemented in the baseband apparatus 1103, and the baseband apparatus 1103 includes a baseband processor.

The baseband apparatus 1103 may include, for example, at least one baseband processing unit, where a plurality of chips are disposed on the baseband processing unit. As shown in FIG. 11, one of the chips is, for example, the baseband processor, and connected to the memory 1105 through a bus interface, to invoke the program in the memory 1105 to perform the operations of the network device shown in the foregoing method embodiment.

The network-side device may further include a network interface 1106, where the interface is, for example, a common public radio interface (CPRI).

Specifically, the network-side device 1100 according to this embodiment of this application further includes instructions or programs stored in the memory 1105 and capable of running on the processor 1104, and the processor 1104 calls the instructions or programs in the memory 1105 to execute the methods performed by the modules shown in FIG. 7 or FIG. 8, with the same technical effects achieved. To avoid repetition, details are not described herein again.

An embodiment of this application further provides a readable storage medium. The readable storage medium stores a program or instructions. When the program or instructions are executed by a processor, each process of the foregoing embodiment of the information transmission method is implemented, with the same technical effect achieved. To avoid repetition, details are not described herein again.

The processor is a processor in the terminal described in the foregoing embodiments. The readable storage medium includes a computer-readable storage medium, for example, a computer read only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instructions to implement each process of the embodiment of the information transmission method, with the same technical effect achieved. To avoid repetition, details are not described herein again. It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and when being executed by at least one processor, the computer program/program product is configured to implement the processes of the foregoing embodiments of the information transmission method, with the same technical effects achieved. To avoid repetition, details are not repeated herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. However, in many cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. An information transmission method, comprising:
performing, by a first protocol layer entity, a first operation, wherein the first operation comprises at least one of the following:
sending first information to a second protocol layer entity, wherein the first information is used for requesting information about a data object associated with a data object of the first protocol layer entity from the second protocol layer entity, and the data object comprises at least one of a data packet, a data packet group, or a service data unit (SDU); or
receiving second information from the second protocol layer entity, wherein the second information is a first response message to the first information, or the second information comprises related information of a data object of the second protocol layer entity; wherein
the first protocol layer entity and the second protocol layer entity are located in a same communication device.

2. The method according to claim 1, wherein the first information comprises at least one of the following:
related information of a first data object, wherein the first data object is a data object of the first protocol layer entity, and the first data object comprises at least one of a first data packet, a first data packet group, or a first SDU;
related information of a second data object, wherein the second data object is a data object associated with the first data object; or
first request information, wherein the first request information is used to request the second protocol layer entity to obtain a related status of the second data object.

3. The method according to claim 2, wherein the second data object comprises at least one of a second data packet or a second data packet group; and
the second data packet comprises at least one of the following:
a data packet associated with the first data packet;
a data packet associated with a data packet group to which the first data packet belongs;
a data packet associated with the first data packet group;
a data packet associated with a data packet corresponding to the first SDU;
a data packet associated with a data packet group corresponding to the first SDU; or
a data packet associated with a data packet group to which a data packet corresponding to the first SDU belongs;
and/or
the second data packet group comprises at least one of the following:
a data packet group associated with the first data packet;
a data packet group associated with the data packet group to which the first data packet belongs;
a data packet group associated with the first data packet group;
a data packet group associated with a data packet corresponding to the first SDU;
a data packet group associated with a data packet group corresponding to the first SDU; or
a data packet group associated with a data packet group to which a data packet corresponding to the first SDU belongs.

4. The method according to claim 2, wherein
the related information of the first data object comprises at least one of the following: an identifier related to the first data object or a status related to the first data object;
and/or
the related information of the second data object comprises an identifier related to the second data object.

5. The method according to claim 4, wherein the identifier related to the first data object comprises at least one of the following:
an identifier of the first data packet;
a sequence number (SN) of the first data packet;
a quality of service (QOS) flow identifier corresponding to the first data packet;
an identifier of a protocol layer corresponding to the first data packet;
an identifier of the first data packet group;
an SN of the first data packet group;
a QoS flow identifier corresponding to the first data packet group;
an identifier of a protocol layer corresponding to the first data packet group;
an identifier of a data packet corresponding to the first SDU;
an SN of a data packet corresponding to the first SDU;
a QoS flow identifier corresponding to a data packet corresponding to the first SDU;
an identifier of a protocol layer corresponding to a data packet corresponding to the first SDU;
an identifier of a data packet group corresponding to the first SDU;
an SN of a data packet group corresponding to the first SDU;
a QoS flow identifier corresponding to a data packet group corresponding to the first SDU; or
an identifier of a protocol layer corresponding to a data packet group corresponding to the first SDU.

6. The method according to claim 5, wherein the identifier of the protocol layer comprises at least one of the following:
a packet data convergence protocol (PDCP) SN;
a data radio bearer (DRB) identifier;
a radio link control (RLC) bearer identifier; or
a media access control (MAC) logical channel identifier.

7. The method according to claim 4, wherein the status related to the first data object comprises at least one of the following:
a status of the first data packet;
a status of the first data packet group;
a status of an SDU corresponding to the first data packet;
a status of an SDU corresponding to the first data packet group;
a status of the first SDU;
a status of a data packet corresponding to the first SDU; or
a status of a data packet group corresponding to the first SDU.

8. The method according to claim 4, wherein the identifier related to the second data object comprises at least one of the following:
an identifier of the second data object;
an SN of the second data object;
a QoS flow identifier corresponding to the second data object; or
an identifier of a protocol layer corresponding to the second data object.

9. The method according to claim 7, wherein the status of the data packet or the data packet group comprises at least one of the following:
the data packet or data packet group has been correctly transmitted;
the data packet or data packet group has not been correctly transmitted;
an SDU corresponding to the data packet or the data packet group has not been correctly transmitted;
the data packet or data packet group has been delivered to a lower layer or an upper layer;
the data packet or data packet group has not been delivered to the lower layer or the upper layer;
the SDU corresponding to the data packet or the data packet group has not been delivered to the lower layer or the upper layer;
the data packet or data packet group has been discarded;
the data packet or data packet group has not been discarded;
an SDU corresponding to the data packet or the data packet group has been discarded;
the SDU corresponding to the data packet or the data packet group has not been discarded;
a delay of the data packet or a delay of the data packet group exceeds a preset time;
the delay of the data packet or the delay of the data packet group does not exceed the preset time;
a discard timer corresponding to the SDU corresponding to the data packet or the data packet group has expired;
the discard timer corresponding to the SDU corresponding to the data packet or the data packet group has not expired;
a remaining delay corresponding to the data packet or the data packet group is less than a preset threshold; or
the remaining delay corresponding to the data packet or the data packet group is greater than or equal to the preset threshold.

10. The method according to claim 7, wherein the status of the SDU comprises at least one of the following:
the SDU has been correctly transmitted;
the SDU has not been correctly transmitted;
a data packet or data packet group corresponding to the SDU has not been correctly transmitted;
the data packet or data packet group corresponding to the SDU has been delivered to the lower layer or the upper layer;
the data packet or data packet group corresponding to the SDU has not been delivered to the lower layer or the upper layer;
the SDU has been delivered to the lower layer or the upper layer;
the SDU has not been delivered to the lower layer or the upper layer;
the SDU has been discarded;
the SDU has not been discarded;
the data packet or data packet group corresponding to the SDU has been discarded;
the data packet or data packet group corresponding to the SDU has not been discarded;
a delay of the SDU exceeds a preset time;
the delay of the SDU does not exceed the preset time;
a discard timer corresponding to the data packet or the data packet group corresponding to the SDU has expired;
the discard timer corresponding to the data packet or the data packet group corresponding to the SDU has not expired;
a remaining delay corresponding to the SDU is less than a preset threshold; or the remaining delay corresponding to the SDU is greater than or equal to the preset threshold.

11. The method according to claim 2, wherein
the first data packet comprises at least one of the following: a data packet in the first protocol layer entity, a problematic data packet, a data packet corresponding to a problematic SDU, a data packet corresponding to an SDU in the first protocol layer entity, or a data packet corresponding to the first SDU;
and/or
the first data packet group comprises at least one of the following: a data packet group in the first protocol layer entity, a problematic data packet group, a data packet group corresponding to a problematic SDU, a data packet group corresponding to an SDU in the first protocol layer entity, or a data packet group corresponding to the first SDU;
and/or
the first SDU comprises at least one of the following: a problematic SDU, an SDU in the first protocol layer entity, an SDU corresponding to a problematic data packet, an SDU corresponding to a problematic data packet group, an SDU corresponding to a data packet in the first protocol layer entity, or an SDU corresponding to a data packet group in the first protocol layer entity.

12. The method according to claim 11, wherein the problematic data packet or data packet group comprises at least one of the following:
a data packet or data packet group that has not been correctly transmitted;
a data packet or data packet group expected not to be correctly transmitted;
a data packet or data packet group corresponding to an SDU that has not been correctly transmitted;
a data packet or data packet group corresponding to an SDU expected not to be correctly transmitted;
a data packet or data packet group that has not been delivered to the lower layer or upper layer;
a data packet or data packet group expected not to be delivered to the lower layer or upper layer;
a data packet or data packet group corresponding to an SDU that has not been delivered to the lower layer or upper layer;
a data packet or data packet group corresponding to an SDU expected not to be delivered to the lower layer or upper layer;
a data packet or data packet group that has been discarded;
a data packet or data packet group expected to be discarded;
a data packet or data packet group corresponding to an SDU that has been discarded;
a data packet or data packet group corresponding to an SDU expected to be discarded;
a data packet or data packet group with a delay exceeding a preset time;
a data packet or data packet group expected to have a delay exceeding a preset time;
a data packet or data packet group corresponding to an SDU with a delay exceeding a preset time;
a data packet or data packet group corresponding to an SDU expected to have a delay exceeding a preset time;
a data packet or data packet group with a corresponding discard timer that has expired;
a data packet or data packet group expected to have a corresponding discard timer expire;
a data packet or data packet group corresponding to an SDU with a corresponding discard timer that has expired;
a data packet or data packet group corresponding to an SDU expected to have a corresponding discard timer expire;
a data packet or data packet group corresponding to an SDU with a remaining delay less than a preset threshold; or
a data packet or data packet group corresponding to an SDU expected to have a remaining delay less than the preset threshold;
or,
wherein the problematic SDU comprises at least one of the following:
an SDU that has not been correctly transmitted;
an SDU expected not to be correctly transmitted;
an SDU corresponding to a data packet or data packet group that has not been correctly transmitted;
an SDU corresponding to a data packet or data packet group expected not to be correctly transmitted;
an SDU that has not been delivered to the lower layer or upper layer;
an SDU expected not to be delivered to the lower layer or upper layer;
an SDU corresponding to a data packet or data packet group that has not been delivered to the lower layer or upper layer;
an SDU corresponding to a data packet or data packet group expected not to be delivered to the lower layer or upper layer;
an SDU that has been discarded;
an SDU expected to be discarded;
an SDU corresponding to a data packet or data packet group that has been discarded;
an SDU corresponding to a data packet or data packet group expected to be discarded;
an SDU with a delay exceeding a preset time;
an SDU expected to have a delay exceeding a preset time;
an SDU corresponding to a data packet or data packet group with a delay exceeding a preset time;
an SDU corresponding to a data packet or data packet group expected to have a delay exceeding a preset time;
an SDU with a corresponding discard timer that has expired;
an SDU expected to have a corresponding discard timer expire;
an SDU corresponding to a data packet or data packet group with a corresponding discard timer that has expired;
an SDU corresponding to a data packet or data packet group expected to have a corresponding discard timer expire;
an SDU corresponding to a data packet or data packet group with a remaining delay less than a preset threshold;
an SDU corresponding to a data packet or data packet group expected to have a remaining delay less than the preset threshold;
an SDU expected to have a remaining delay less than the preset threshold; or
an SDU expected to have a remaining delay less than the preset threshold.

13. The method according to claim 10, wherein the remaining delay of the data packet or data packet group comprises at least one of the following:
a remaining packet delay budget (PDB) or a remaining protocol data unit set delay budget (PSDB) of the data packet or data packet group;
a remaining PDB or a remaining PSDB of the data packet or data packet group in the communication device or at the first protocol layer; or
a remaining delay requirement of the data packet or data packet group in the communication device or at the second protocol layer.

14. The method according to claim 1, wherein the first response message comprises at least one of the following:
first acknowledgment information, wherein the first acknowledgment information is used to indicate whether the second protocol layer entity has received the first information, or the first acknowledgment information is used to indicate whether the second protocol layer entity has not received the first information;
an identifier related to a third data object, wherein the third data object comprises at least part of data objects in the first data object;
an identifier related to a fourth data object, wherein the fourth data object comprises at least part of data objects associated with the first data object;
a status related to the fourth data object;
an identifier related to a fifth data object, wherein the fifth data object comprises at least part of data objects in the second data object; or
a status related to the fifth data object.

15. The method according to claim 1, wherein the related information of the data object of the second protocol layer entity comprises at least one of the following:
related information of a sixth data object, wherein the sixth data object is a data object of the second protocol layer entity, and the sixth data object comprises at least one of a third data packet or a third data packet group; or
related information of a seventh data object, wherein the seventh data object is a data object associated with the sixth data object.

16. The method according to claim 15, wherein the sixth data object comprises at least one of the following:
a data object currently being processed;
a data object corresponding to an SDU currently being processed;
a data object that has not been correctly transmitted;
a data object corresponding to an SDU that has not been correctly transmitted;
a data object that has not been delivered to the lower layer or upper layer;
a data object corresponding to an SDU that has not been delivered to the lower layer or upper layer;
a data object that has been discarded;
a data object corresponding to an SDU that has been discarded;
a data object with a delay exceeding a preset time;
a data object corresponding to an SDU with a delay exceeding a preset time;
a data object with a discard timer that has expired;
a data object corresponding to an SDU with a discard timer that has expired;
a data object with a remaining delay less than a preset threshold; or
a data object corresponding to an SDU with a remaining delay less than preset threshold; or,
wherein the seventh data object comprises at least one of the following:
a data packet associated with the third data packet;
a data packet group associated with the third data packet;
a data packet associated with a data packet group to which the third data packet belongs;
a data packet group associated with a data packet group to which the third data packet belongs;
a data packet associated with the third data packet group; or
a data packet group associated with the third data packet group.

17. The method according to claim 1, wherein the sending, by first protocol layer entity, first information to a second protocol layer entity comprises:
in a case that a first condition is met, sending, by the first protocol layer entity, the first information to the second protocol layer entity; wherein
the first condition comprises at least one of the following:
first indication information sent by a network-side device has been received, wherein the first indication information is used to indicate the first protocol layer entity to send the first information to the second protocol layer entity;
second indication information sent by an upper layer of the first protocol layer entity has been received, wherein the second indication information is used to indicate the first protocol layer entity to send the first information to the second protocol layer entity;
a first request message sent by a first target protocol layer entity has been received, wherein the first request message is used for requesting the first protocol layer entity to send the first information to the second protocol layer entity;
a data packet or data packet group has arrived at the first protocol layer entity;
an upper layer data packet has arrived at the first protocol layer entity;
the first protocol layer entity has delivered a data packet or a data packet group or a PDCP protocol data unit (PDU) or a PDCP SDU to the lower layer or the upper layer;
a data packet, a data packet group, or an SDU has been correctly transmitted;
a data packet, a data packet group, or an SDU has not been correctly transmitted;
an SDU corresponding to the data packet or the data packet group has not been correctly transmitted;
a data packet or data packet group corresponding to the SDU has not been correctly transmitted;
a data packet, a data packet group, or an SDU has been delivered to the lower layer or the upper layer;
a data packet, a data packet group, or an SDU has not been delivered to the lower layer or the upper layer;
the SDU corresponding to the data packet or the data packet group has not been delivered to the lower layer or the upper layer;
the data packet or data packet group corresponding to the SDU has not been delivered to the lower layer or the upper layer;
a data packet, a data packet group, or an SDU has been discarded;
a data packet, a data packet group, or an SDU has not been discarded;
an SDU corresponding to the data packet or the data packet group has been discarded;
the SDU corresponding to the data packet or the data packet group has not been discarded;
the data packet or data packet group corresponding to the SDU has been discarded;
the data packet or data packet group corresponding to the SDU has not been discarded;
a delay of the data packet, the data packet group, or the SDU exceeds a preset time;
a delay of the data packet, the data packet group, or the SDU does not exceed the preset time;
a discard timer corresponding to the SDU corresponding to the data packet or the data packet group has expired;
the discard timer corresponding to the SDU corresponding to the data packet or the data packet group has not expired;
a discard timer corresponding to the data packet or the data packet group corresponding to the SDU has expired;
the discard timer corresponding to the data packet or the data packet group corresponding to the SDU has not expired;
a remaining delay corresponding to the data packet, the data packet group, or the SDU is less than a preset threshold; or
the remaining delay corresponding to the data packet, the data packet group, or the SDU is greater than or equal to the preset threshold.

18. An information transmission method, comprising:
performing, by a second protocol layer entity, a second operation, wherein the second operation comprises at least one of the following:
receiving first information from a first protocol layer entity, wherein the first information is used for requesting information about a data object associated with a data object of the first protocol layer entity from the second protocol layer entity, and the data object comprises at least one of a data packet, a data packet group, or a service data unit (SDU); or
sending second information to the first protocol layer entity, wherein the second information is a first response message to the first information, or the second information comprises related information of a data object of the second protocol layer entity; wherein
the first protocol layer entity and the second protocol layer entity are located in a same communication device.

19. A communication device, comprising a processor and a memory, wherein a program or instructions capable of running on the processor are stored in the memory, wherein the communication device comprises a first protocol layer entity, wherein the program or instructions, when executed by the processor, cause the first protocol layer entity to perform:
performing a first operation, wherein the first operation comprises at least one of the following:
sending first information to a second protocol layer entity, wherein the first information is used for requesting information about a data object associated with a data object of the first protocol layer entity from the second protocol layer entity, and the data object comprises at least one of a data packet, a data packet group, or a service data unit (SDU); or
receiving second information from the second protocol layer entity, wherein the second information is a first response message to the first information, or the second information comprises related information of a data object of the second protocol layer entity; wherein
the first protocol layer entity and the second protocol layer entity are located in a same communication device.

20. A communication device, comprising a processor and a memory, wherein a program or instructions capable of running on the processor are stored in the memory, and when the program or instructions are executed by the processor, the steps of the information transmission method according to claim 18 are implemented.
